(19) United States
(12) Patent Application Publication
(10) Pub. No.: US 2026/0091545 A1
(43) Pub. Date: Apr. 2, 2026

(54) DECORATIVE SHEET FOR VACUUM FORMING AND DECORATIVE MEMBER

(71) Applicant: Dai Nippon Printing Co., Ltd., Tokyo (JP)

(72) Inventors: Hironaga Usui, Tokyo (JP); Natsuo Sugita, Tokyo (JP); Osamu Watanabe, Tokyo (JP); Michiko Ito, Tokyo (JP); Emi Nissato, Tokyo (JP)

(73) Assignee: Dai Nippon Printing Co., Ltd., Tokyo (JP)

(21) Appl. No.: 19/110,255

(22) PCT Filed: Sep. 12, 2023
(86) PCT No.: PCT/JP2023/033210

§ 371 Date: Mar. 10, 2025

(30) Foreign Application Priority Data
Sep. 12, 2022 (JP) 2022-144543
Mar. 3, 2023 (JP) 2023-032575

(51) Int. Cl. B29C 51/14; B29C 51/10; B29L 31/00; B32B 3/30; B32B 27/08; B32B 27/22; B32B 27/30

(52) U.S. Cl. CPC B29C 51/14; B29C 51/10; B32B 3/30; B32B 27/08; B32B 27/22; B32B 27/304; B29L 2031/722; B32B 2250/02; B32B 2250/246; B32B 2255/10; B32B 2255/26; B32B 2307/4023; B32B 2307/4026; B32B 2307/536; B32B 2307/7376; B32B 2451/00

(57) ABSTRACT

The present disclosure provides a decorative sheet for vacuum forming, the decorative sheet includes: a first vinyl chloride based resin layer; a design layer; a second vinyl chloride based resin layer; and a surface protective layer in this order, in a thickness direction, wherein the first vinyl chloride based resin layer and the second vinyl chloride based resin layer respectively include vinyl chloride based resin and aliphatic dibasic acid based plasticizer; a nanoindentation hardness of the first vinyl chloride based resin layer, in a cross-section in a thickness direction, is 160 MPa or less; and a nanoindentation hardness of the second vinyl chloride based resin layer, in a cross-section in a thickness direction, is 165 MPa or more.

### TECHNICAL FIELD

The present disclosure relates to a decorative sheet for vacuum forming and a decorative member.

### BACKGROUND ART

A decorative member including a base member and a decorative sheet is known as, for example, an interior member or an exterior member used for construction materials. A vacuum forming method is known as one of the methods for imparting a designability to a steric shaped base member using a decorative sheet. An example of a method for producing a decorative member by a vacuum forming method is a method wherein a decorative sheet is shaped along the steric shape of a base member and adhered by vacuum adsorbing a decorative sheet softened by heating to the base member shaped into a steric shape, by a depressurizing operation.

For example, Patent Document 1 discloses a decorative sheet for forming a membrane comprising, from a surface layer, a fluorine based resin film with an embossed surface, a synthetic resin adhesive layer, a hard vinyl chloride based resin sheet including a predetermined amount of plasticizer, and a design layer, stacked in this order.

Also, Patent Document 2 discloses a decorative sheet for forming comprising a polyvinyl chloride based resin substrate and a pattern layer on at least one surface side of the polyvinyl chloride based resin substrate, wherein the polyvinyl chloride based resin substrate includes 12 parts by mass or more of diisononyl phthalate as a plasticizer, when the mass of the polyvinyl chloride based resin constituting the polyvinyl chloride based resin substrate is regarded as 100 parts by mass.

### CITATION LIST

### Patent Documents

Patent Document 1: Registered Utility Model No. 3030051
Patent Document 2: Japanese Patent Application Laid-Open (JP-A) No. 2019-177681

### SUMMARY OF DISCLOSURE

### Technical Problem

Since decorative sheet for vacuum forming is formed and adhered along the steric shape of a base member, flexibility is required. Also, it is conventionally believed that, in view of the processing suitability in the vacuum forming, the flexibility of each layer in a decorative sheet including a plurality of layers is equivalent with each other. Meanwhile, when a high flexibility is imparted to the entire decorative sheet, the scratch resistance of the decorative sheet may be deteriorated. Also, in low temperature environments such as winter and cold regions, impact resistance of the decorative sheet decreases due to a decrease in the flexibility of the decorative sheet, and when the decorative sheet is transported or stored, the decorative sheet may be prone to cracking due to an impact imparted to the decorative sheet. Also, it may lead to a deterioration in processing suitability in vacuum forming. Incidentally, in order to prevent deterioration of processing suitability in vacuum forming, the decorative sheet is generally heated during vacuum forming, and the decorative sheet may break during forming due to the impact or tension imparted to the sheet in a low temperature environment before heating.

The present disclosure has been made in view of the above circumstances, and an object of the present disclosure is to provide a decorative sheet for vacuum forming with good processing suitability and high scratch resistance, and capable of suppressing the deterioration of impact resistance and processing suitability under a low temperature environment.

### Solution to Problem

The present disclosure provides a decorative sheet for vacuum forming, the decorative sheet includes: a first vinyl chloride based resin layer; a design layer; a second vinyl chloride based resin layer; and a surface protective layer in this order, in a thickness direction, wherein the first vinyl chloride based resin layer and the second vinyl chloride based resin layer respectively include vinyl chloride based resin and a plasticizer; the plasticizer is an aliphatic dibasic acid based plasticizer; a nanoindentation hardness of the first vinyl chloride based resin layer, in a cross-section in a thickness direction, is 160 MPa or less; and a nanoindentation hardness of the second vinyl chloride based resin layer, in a cross-section in a thickness direction, is 165 MPa or more.

The present disclosure provides a method for producing a decorative sheet for vacuum forming, the method comprising: a design layer forming step of forming a design layer on one surface of a first vinyl chloride based resin layer; a disposing step of disposing a second vinyl chloride based resin layer on a surface of the design layer that is opposite side to the first vinyl chloride based resin layer; and a surface protective layer forming step of forming a surface protective layer on a surface of the second vinyl chloride based resin layer that is opposite side to the design layer, wherein the first vinyl chloride based resin layer and the second vinyl chloride based resin layer respectively include vinyl chloride based resin and aliphatic dibasic acid based plasticizer; a nanoindentation hardness of the first vinyl chloride based resin layer, in a cross-section in a thickness direction, is 160 MPa or less; and a nanoindentation hardness of the second vinyl chloride based resin layer, in a cross-section in a thickness direction, is 165 MPa or more.

Also, the present disclosure provides a decorative member comprising: a base member; and the decorative sheet for vacuum forming described above.

The present disclosure provides a method for producing the decorative member described above, the method comprising: a preparing step of preparing a base member and the decorative sheet for vacuum forming: a softening step of softening the decorative sheet for vacuum forming by heating; and a vacuum adsorbing step of vacuum adsorbing the softened decorative sheet for vacuum forming to a shape of the base member by a decompression operation.

### Advantageous Effects of Disclosure

The present disclosure has an effect of being able to provide a decorative sheet for vacuum forming with good processing suitability and high scratch resistance, and capable of suppressing the deterioration of impact resistance and processing suitability under a low temperature environment.

### BRIEF DESCRIPTION OF DRAWINGS

FIG. 1 is a schematic cross-sectional view exemplifying a decorative sheet for vacuum forming in the present disclosure.

FIG. 2 is a schematic cross-sectional view exemplifying a decorative sheet for vacuum forming in the present disclosure.

FIG. 3 are schematic cross-sectional views exemplifying the convexoconcave shape of a second vinyl chloride based resin layer in the present disclosure.

FIG. 4 are schematic cross-sectional views exemplifying the convexoconcave shape of a second vinyl chloride based resin layer in the present disclosure.

FIG. 5 are schematic cross-sectional views exemplifying the convexoconcave shape of a second vinyl chloride based resin layer in the present disclosure.

FIG. 6 is a schematic cross-sectional view exemplifying a decorative sheet for vacuum forming in the present disclosure.

FIG. 7 are schematic cross-sectional views exemplifying a second vinyl chloride based resin layer and a brightness layer in the present disclosure.

FIG. 8 is a schematic cross-sectional view exemplifying a second vinyl chloride based resin layer and a brightness layer in the present disclosure.

FIG. 9 is a schematic cross-sectional view exemplifying a decorative sheet for vacuum forming in the present disclosure.

FIG. 10 are schematic cross-sectional views exemplifying a method for producing a decorative sheet in the present disclosure.

FIG. 11 are schematic cross-sectional views exemplifying a decorative member in the present disclosure.

### DESCRIPTION OF EMBODIMENTS

Embodiments are hereinafter explained with reference to, for example, drawings. However, the present disclosure is implemented in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure.

In the present descriptions, in expressing an aspect wherein some member is placed on the other member, when described as merely “above” or “below”, unless otherwise stated, it includes both of the following cases: a case wherein some member is placed directly on or directly below the other member so as to be in contact with the other member, and a case wherein some member is placed on the upper side or the lower side of the other member via yet another member. Also, in the present descriptions, on the occasion of expressing an aspect wherein some member is placed on the surface of the other member, when described as merely “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

### A. Decorative Sheet for Vacuum Forming

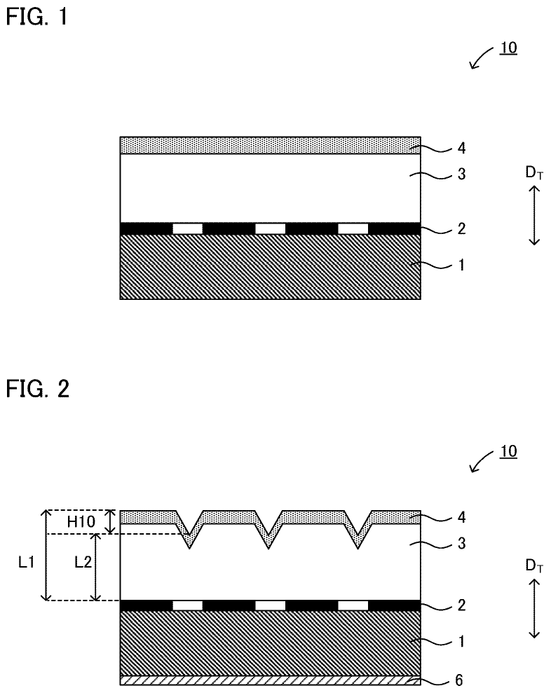

The decorative sheet for vacuum forming in the present disclosure will be hereinafter described in detail. FIG. 1 and FIG. 2 are schematic cross-sectional views exemplifying the decorative sheet for vacuum forming in the present disclosure. The decorative sheet for vacuum forming 10 shown in FIG. 1 includes a first vinyl chloride based resin layer 1, a design layer 2, a second vinyl chloride based resin layer 3, and a surface protective layer 4 in this order, in a thickness direction Dr. The first vinyl chloride based resin layer 1 and the second vinyl chloride based resin layer 3 respectively include vinyl chloride based resin and aliphatic dibasic acid based plasticizer. Further, in the present disclosure, a nanoindentation hardness of the first vinyl chloride based resin layer 1, in a cross-section in a thickness direction, is 160 MPa or less; and a nanoindentation hardness of the second vinyl chloride based resin layer, in a cross-section in a thickness direction, is 165 MPa or more. Also, the decorative sheet for vacuum forming 10 shown in FIG. 2 includes a rear surface primer layer 6, a first vinyl chloride based resin layer 1, a design layer 2, a second vinyl chloride based resin layer 3, and a surface protective layer 4 in this order, in a thickness direction Dr. Also, the decorative sheet for vacuum forming 10 shown in FIG. 2 includes a convexoconcave shape on a surface protective layer 4 side surface.

In the decorative sheet for vacuum forming in the present disclosure, since the nanoindentation hardness of the first vinyl chloride based resin layer 1, in a cross-section in a thickness direction, is a predetermined value or less, the first vinyl chloride based resin layer 1 is excellent in flexibility so that it has excellent processing suitability during vacuum forming. Further, since the nanoindentation hardness of the second vinyl chloride based resin layer 3, in a cross-section in a thickness direction, is a predetermined value or more, the scratch resistance is excellent.

In the decorative sheet for vacuum forming in the present disclosure, since the first vinyl chloride based resin layer and the second vinyl chloride based resin layer include aliphatic dibasic acid based plasticizer, the cold resistance is improved. Therefore, the reduction of flexibility can be suppressed even when transported or stored in low temperature environments such as winter and cold regions. For the reasons described above, the decrease in impact resistance can be suppressed, and the deterioration of processing suitability in vacuum forming can be suppressed. Also, by including the surface protective layer, the bleed out of the plasticizer can be suppressed.

### 1. First Vinyl Chloride Based Resin Layer

The first vinyl chloride based resin layer in the present disclosure includes vinyl chloride based resin and aliphatic dibasic acid based plasticizer, and the nanoindentation hardness of the first vinyl chloride based resin layer, in the cross-section in the thickness direction, is a predetermined value or less.

### 1-1. Nanoindentation Hardness

The nanoindentation hardness of the first vinyl chloride based resin layer in the present disclosure, in a cross-section in a thickness direction, is usually 160 MPa or less, may be 150 MPa or less, and may be 120 MPa or less. When the nanoindentation hardness of the first vinyl chloride based resin layer is high, the flexibility of the first vinyl chloride based resin layer is low, so that the processing suitability of the decorative sheet in vacuum forming decreases. Meanwhile the nanoindentation hardness of the first vinyl chloride based resin layer is, for example, 30 MPa or more, may be 60 MPa or more, and may be 100 MPa or more.

The nanoindentation hardness of the first vinyl chloride based resin layer, in a cross-section in a thickness direction, is a value determined from a load-displacement curve from indenter loading to unloading obtained by a hardness measurement by the nanoindentation method. The indentation hardness of the first vinyl chloride based resin layer is measured by preparing a measurement sample, wherein the cross-section of the first vinyl chloride based resin layer is exposed, by the following method, and measuring by the following method at ordinary temperature.

### (Preparation of Measurement Sample)

A cut sample is prepared by cutting the decorative sheet for vacuum forming into an arbitrary size. An embedded sample, wherein the cut sample is embedded in a resin, is prepared by embedding the cut sample into resin (ordinary temperature curing type 2-component epoxy curable resin), and leaving it to stand at room temperature for 24 hours or more to cure.

The embedded sample is cut vertically using a cutting device to prepare a sample for measuring nanoindentation hardness, wherein the cross-section of the decorative sheet for vacuum forming is exposed. Examples of the cutting device may include a product name of “Ultramicrotome EM UC7” from Leica Microsystems, Inc.

### (Method for Measuring)

The indentation method is a method to measure the relationship between the load and displacement, from the compression of the indenter to a certain load on the sample surface, until the removal of the indenter. In the indentation method, the indentation hardness H_{IT} is calculated from the size of the indentation mark at the maximum compression.

Specifically, using the following nanoindenter, a Berkovich indenter (material: a triangular pyramid diamond) is pressed vertically on the cutting surface of the measurement sample described above, and measured. The measurement device and measurement conditions are as follows. Here, the position where the Berkovich indenter is pressed is preferably an approximate center, in the thickness direction, of the first vinyl chloride based resin layer. The approximate center means that, when the thickness of the first vinyl chloride based resin layer is defined as T [μm], the deviation from the center in the thickness direction of the first vinyl chloride based resin layer is within ±0.1 T.
Used device: nanoindenter (TI 950 TriboIndenter from Bruker Corporation)
Used indenter: a Berkovich indenter (model number: TI-0039 from Bruker Corporation)
Compression condition: load control method
Maximum load: 200 μN
Load application time: 20 seconds (0 μN to 200 μN, load variation rate: 10 μN/sec)·
Retention time: 10 seconds
Retention load: 200 μN
Unloading time: 20 seconds (200 μN to 0 μN, load variation rate: −10 μN/sec)

The indentation hardness of the first vinyl chloride based resin layer can be calculated as follows. Firstly, a load-displacement curve is prepared by continuously measuring the compression depth h (nm) corresponding to the compression load F (N). By analyzing the prepared load-displacement curve, the indentation hardness H_{IT} can be calculated as a value obtained by dividing the maximum compression load Fₘₐₓ (N) by the projection area Aₚ (mm²) where the indenter and the first vinyl chloride based resin layer are in contact with each other at that time (following formula (1)).

$${H}_{IT} = {F}_{m ax} / {A}_{p} \qquad ( 1 )$$

Here, Aₚ is a contact projection area wherein the indenter tip curvature is corrected by Oliver-Pharr method, using a reference sample fused quartz (5-0098 from Bruker Corporation).

In the present descriptions, the indentation hardness of the first vinyl chloride based resin layer is an arithmetic average value of the value obtained by measuring at ten locations. Here, the above 10 locations are positioned, at approximate center in the thickness direction of the first vinyl chloride based resin layer described above, at intervals of 10 μm each away from each other in the perpendicular direction from the thickness direction. For example, after measuring at the first location at a predetermined position at approximate center in the thickness direction of the first vinyl chloride based resin layer, the second location is measured at approximate center in the thickness direction of the first vinyl chloride based resin layer, by shifting the Berkovich indenter 10 μm in perpendicular direction to the thickness direction. After the second location is measured, the third location is measured at approximate center in the thickness direction of the first vinyl chloride based resin layer, by shifting the Berkovich indenter 10 μm in perpendicular direction to the thickness direction. By repeat this, measurements at 10 locations are carried out. Also, the atmosphere for measuring indentation hardness is at temperature of 23° C.±5° C. and humidity of 40% to 65%.

The nanoindentation hardness of the first vinyl chloride based resin layer, in a cross-section in a thickness direction may be adjusted, for example, by a method wherein the content of the aliphatic dibasic acid based plasticizer is adjusted. Specifically, by reducing the content of aliphatic dibasic acid based plasticizer, the value of the nanoindentation hardness can be increased, and by increasing the content of aliphatic dibasic acid based plasticizer, the value of the nanoindentation hardness can be reduced. Also, the nanoindentation hardness may be adjusted by a method wherein the type of the aliphatic dibasic acid based plasticizer is changed.

### 1-2. Composition of First Vinyl Chloride Based Resin Layer

### (1) Vinyl Chloride Based Resin

The first vinyl chloride based resin layer in the present disclosure includes vinyl chloride based resin. The vinyl chloride based resin preferably includes a unit structure of —(CH₂—CHCl)—. Further, the vinyl chloride based resin preferably includes a unit structure of —(CH₂—CHCl)— as a main unit structure. Examples of the vinyl chloride based resin may include the following (i) to (iii).
(i) monopolymer of vinyl chloride monomer
(ii) chlorinated vinyl chloride based resin
(iii) vinyl chloride copolymer obtained by copolymerizing vinyl chloride monomer with another monomer

Examples of another monomer in (iii) above may include vinyl acetate, ethylene, vinylidene chloride, vinyl fluoride, acrylonitrile, styrene, methyl acrylate, and methyl methacrylate. The first vinyl chloride based resin layer may include only one type of the vinyl chloride based resin, and may include two types or more. For example, the first vinyl chloride based resin layer may include two types or more vinyl chloride based resins among (i) to (iii) above.

The first vinyl chloride based resin layer may include only the vinyl chloride based resin as a resin, and may further include resins other than the vinyl chloride based resin. In the latter case, the first vinyl chloride based resin layer preferably includes the vinyl chloride based resin as a main component of the resin (the component with the highest mass ratio). The ratio of the vinyl chloride based resin with respect to all the resins included in the first vinyl chloride based resin layer is, for example, 50% by mass or more, may be 70% by mass or more, and may be 90% by mass or more. Examples of resins other than the vinyl chloride based resin may include acrylic based resins, ethylene-vinyl acetate copolymer, styrene-butadiene copolymer, and styrene-butadiene-acrylonitrile copolymer.

The first vinyl chloride based resin layer usually includes vinyl chloride based resin as a main component. The ratio of the vinyl chloride based resin in the first vinyl chloride based resin layer is, for example, 70% by mass or more, and may be 80% by mass or more.

### (2) Aliphatic Dibasic Acid Based Plasticizer

The first vinyl chloride based resin layer in the present disclosure includes aliphatic dibasic acid based plasticizer. By using the aliphatic dibasic acid based plasticizer, the flexibility at low temperature is improved, compared to, for example, phthalic acid based plasticizer, so that a decorative sheet with cold resistant can be obtained.

The cold resistance of the vinyl chloride based resin layer can be evaluated by a Clash-berg softening temperature test according to JIS K 6773. For example, Clash-berg softening temperature of a soft vinyl chloride sheet, with a thickness of 1 mm, including 50 phr phthalate based plasticizers such as diisononyl phthalate (DINP), bis(2-ethylhexyl) phthalate (DOP), or diisodecyl phthalate (DIDP) is around −25° C., while Clash-berg softening temperature of a soft vinyl chloride sheet, with a thickness of 1 mm, including 50 phr diisononyl adipate (DINA) that is an aliphatic dibasic acid based plasticizer is around −50° C. Incidentally, the Clash-berg softening temperature test is a test mainly evaluates the torsional stiffness of soft vinyl chloride resins at low temperature. It is a test wherein after cooling a test piece to −55° C., the temperature is raised at 5° C. intervals, the torsion angle at each temperature is measured by applying a predetermined torque, and the temperature when the rigidity modulus of 310 MPa is determined, from the temperature-rigidity modulus curve, as the softening temperature. The lower the Clash-berg softening temperature, the better the cold resistance. Thus, it is surmised that, by using the aliphatic dibasic acid based plasticizer, a vinyl chloride based resin layer with good flexibility at low temperature, compared to a case where phthalic acid based plasticizer is used, can be obtained.

Examples of the aliphatic dibasic acid based plasticizer may include at least one type selected from the group consisting of adipic acid esters, sebacic acid esters and azelaic acid esters. Also, in these esters, aliphatic alcohols with a carbon number of 3 or more and 13 or less can be used as alcohols that constitute esters by dehydration condensation. Also, one type of these alcohols may be used alone, and two types or more may be used in a combination.

As the aliphatic dibasic acid based plasticizer, at least one selected from the group consisting of diisononyl adipate (DINA), dioctyl adipate (DOA), diisodecyl adipate, dibutyl sebacate (DBS), dioctyl sebacate (DOS), and dioctyl azelate (DOZ) can be used. In particular, adipic acid esters are preferable in view of the particularly excellent cold resistance, and diisononyl adipate is particularly preferable.

Whether the aliphatic dibasic acid based plasticizer is included in the first vinyl chloride based resin layer or not can be confirmed by, for example, FT-IR.

Also, an amount of the aliphatic dibasic acid based plasticizer in the first vinyl chloride based resin layer is preferably more than an amount of the aliphatic dibasic acid based plasticizer in the second vinyl chloride based resin layer described below. Specifically, the amount of the aliphatic dibasic acid based plasticizer in the first vinyl chloride based resin layer, with respect to 100 parts by mass of vinyl chloride based resin, is preferably more than an amount of the aliphatic dibasic acid based plasticizer in the second vinyl chloride based resin layer, with respect to 100 parts by mass of vinyl chloride based resin.

The content of the aliphatic dibasic acid based plasticizer in the first vinyl chloride based resin layer is preferably 5 parts by mass or more, and more preferably 8 parts by mass or more, with respect to 100 parts by mass of the vinyl chloride based resin. When the ratio of the plasticizer is low, flexibility may be decreased, and the processing suitability in vacuum forming may be reduced. Meanwhile, the content of the aliphatic dibasic acid based plasticizer is preferably 15 parts by mass or less, and more preferably 12 parts by mass or less, with respect to 100 parts by mass of the vinyl chloride based resin. When the ratio of the plasticizer is high, the plasticizer may bleed out.

The ratio of plasticizer with respect to the vinyl chloride based resin is measured by the following method. In other words, the first vinyl chloride based resin layer is shaved out with a microplane, approximately 10 mg of the resin is sampled, and placed in a 50 mL sample tube bin. Then, 20 mL of a mixture solvent of acetone and hexane (acetone: hexane=7:3, volume ratio) is added to the sample tube bin, cover and shake for 12 hours or more. After shaking, the resultant is pressurized filtered with a filter with a mesh size of 0.2 μm, and the filtrate is measured by gas chromatography mass spectrometry (GC/MS). Thereby, ratio of plasticizer with respect to the vinyl chloride based resin is determined.

Although the first vinyl chloride based resin layer in the present disclosure preferably includes no plasticizer other than the aliphatic dibasic acid based plasticizer, the plasticizer other than the aliphatic dibasic acid based plasticizer may be included. In the latter case, the plasticizer other than the aliphatic dibasic acid based plasticizer included in the first vinyl chloride based resin layer, with respect to total amount of the plasticizers included in the first vinyl chloride based resin layer is, for example, 5% by mass or less, may be 3% by mass or less, and may be 1% by mass or less. Examples of the plasticizer other than the aliphatic dibasic acid based plasticizer may include phthalate based plasticizers, epoxy based plasticizers, and phosphate based plasticizers.

### (3) Others

The first vinyl chloride based resin layer preferably includes a colorant. It can improve the hiding property of the decorative sheet, a decorative sheet less susceptible to the color and pattern of the base member. The first vinyl chloride based resin layer is colored to the desired color, for example, gray, brown, red, blue, and green. The colorant may be selected from various known pigments and dyes. For example, inorganic pigments such as iron black, lead yellow, titanium yellow, Bengal red, cadmium red, ultramarine blue, and cobalt blue; and organic pigments or organic dyes such as quinacridone red, isoindolinone yellow, phthalocyanine blue, nickel-azo complex, azomethine azo based black pigment, and perylene based black pigment can be used.

Also, the first vinyl chloride based resin layer may include various additives as necessary. Examples of the additive may include photostabilizers, ultraviolet ray absorbers, heatstabilizers, surfactants, fillers, and antistatic agents.

### 1-3. First Vinyl Chloride Based Resin Layer

The first vinyl chloride based resin layer may be transparent (colored transparent or colorless transparent), and may be opaque, and it is preferably opaque. The thickness of the first vinyl chloride based resin layer is, for example, 200 μm or less, and may be 180 μm or less. When the first vinyl chloride based resin layer is thick, the processing suitability in vacuum forming may be reduced. Meanwhile, the thickness of the first vinyl chloride based resin layer is, for example, 60 μm or more, and may be 80 μm or more. When the thickness of the first vinyl chloride based resin layer is too thin, the desired hiding function may not be obtained.

### 2. Second Vinyl Chloride Based Resin Layer

The second vinyl chloride based resin layer in the present disclosure is disposed between the surface protective layer and the design layer.

By disposing the second vinyl chloride based resin layer, deterioration of the design layer due to abrasion and chemical contamination can be suppressed. The second vinyl chloride based resin layer includes vinyl chloride based resin and aliphatic dibasic acid based plasticizer. Also, since the nanoindentation hardness of the second vinyl chloride based resin layer, in a cross-section in a thickness direction, is a predetermined value or more, the scratch resistance is improved.

### 2-1. Nanoindentation Hardness

The nanoindentation hardness of the second vinyl chloride based resin layer in the present disclosure, in a cross-section in a thickness direction, is usually 165 MPa or more, may be 170 MPa or more, and may be 180 MPa or more. When the nanoindentation hardness of the second vinyl chloride based resin layer is low, the scratch resistance of the decorative sheet is deteriorated.

Meanwhile, the nanoindentation hardness of the second vinyl chloride based resin layer is, for example, 250 MPa or less, may be 220 MPa or less, and may be 200 MPa or less. When the nanoindentation hardness of the second vinyl chloride based resin layer is high, the processing suitability in vacuum forming may be decreased. Also, since the nanoindentation hardness of the second vinyl chloride based resin layer is the value described above or less, it is easier to carry out the embossing process, and it is easier to form the convexoconcave shape described later.

The method for measuring the nanoindentation hardness of the second vinyl chloride based resin layer is similar to the method for measuring the nanoindentation hardness of the first vinyl chloride based resin layer.

The nanoindentation hardness of the second vinyl chloride based resin layer, in a cross-section in a thickness direction, may be adjusted, for example, by a method wherein the content of the aliphatic dibasic acid based plasticizer is adjusted. Specifically, by reducing the content of the aliphatic dibasic acid based plasticizer, the value of the nanoindentation hardness can be increased, and by increasing the content of the aliphatic dibasic acid based plasticizer, the value of the nanoindentation hardness can be reduced. Also, the nanoindentation hardness may be adjusted by a method wherein the type of the aliphatic dibasic acid based plasticizer is changed.

### 2-2. Composition of Second Vinyl Chloride Based Resin Layer

### (1) Vinyl Chloride Based Resin

The second vinyl chloride based resin layer in the present disclosure includes vinyl chloride based resin. Examples of the vinyl chloride based resin included in the second vinyl chloride based resin layer may include ones similar to those exemplified for the first vinyl chloride based resin layer described above.

The second vinyl chloride based resin layer may include only the vinyl chloride based resin as the resin, and may further include resins other than the vinyl chloride based resin. In the latter case, the second vinyl chloride based resin layer preferably includes the vinyl chloride based resin as a main component of the resin (the component with the highest mass ratio). The ratio of the vinyl chloride based resin with respect to all the resins included in the second vinyl chloride based resin layer is, for example, 50% by mass or more, may be 70% by mass or more, and may be 90% by mass or more. Examples of the resin other than the vinyl chloride based resin may include ones similar to those exemplified for the first vinyl chloride based resin layer described above.

The second vinyl chloride based resin layer usually includes the vinyl chloride based resin as a main component. The ratio of the vinyl chloride based resin in the second vinyl chloride based resin layer is, for example, 70% by mass or more, and may be 80% by mass or more.

### (2) Aliphatic Dibasic Acid Based Plasticizer

The second vinyl chloride based resin layer in the present disclosure includes aliphatic dibasic acid based plasticizer. Examples of the aliphatic dibasic acid based plasticizer included in the second vinyl chloride based resin layer may include ones similar to those exemplified for the first vinyl chloride based resin layer described above. In particular, adipic acid esters are preferable in view of the particularly excellent cold resistance. Further, diisononyl adipate is particularly preferable for the second vinyl chloride based resin layer, since it is not likely to bleed out and has high transparency.

The content of the aliphatic dibasic acid based plasticizer in the second vinyl chloride based resin layer is, for example, 1 part by mass or more, preferably 2 parts by mass or more, and more preferably 4 parts by mass or more, with respect to 100 parts by mass of the vinyl chloride based resin. When the ratio of the plasticizer is low, the processing suitability in vacuum forming may be reduced. Meanwhile, the content of the aliphatic dibasic acid based plasticizer in the second vinyl chloride based resin layer is, for example, less than 15 parts by mass, preferably 10 parts by mass or less, and more preferably 8 parts by mass or less, with respect to 100 parts by mass of the vinyl chloride based resin. When the ratio of the plasticizer is high, the scratch resistance may deteriorate, and the plasticizer may bleed out.

Although the second vinyl chloride based resin layer in the present disclosure preferably includes no plasticizer other than the aliphatic dibasic acid based plasticizer, the plasticizer other than the aliphatic dibasic acid based plasticizer may be included. In the latter case, the plasticizer other than the aliphatic dibasic acid based plasticizer included in the second vinyl chloride based resin layer, with respect to total amount of the plasticizers included in the second vinyl chloride based resin layer is, for example, 5% by mass or less, may be 3% by mass or less, and may be 1% by mass or less. Examples of the plasticizer other than the aliphatic dibasic acid based plasticizer may include ones similar to those exemplified for the first vinyl chloride based resin layer described above.

### (3) Others

Also, the second vinyl chloride based resin layer may include various additives as necessary. Examples of the additive may include photostabilizers, ultraviolet ray absorbers, antioxidants, heatstabilizers, colorants, surfactants, fillers, and antistatic agents.

The ultraviolet ray absorber may be an organic based ultraviolet ray absorber, and may be an inorganic based ultraviolet ray absorber. Examples of the organic ultraviolet ray absorber may include benzotriazole based ultraviolet ray absorbers such as 2-(2-hydroxy-5-methylphenyl)benzotriazole, and 2-(2-hydroxy-3,5-di-tert-amylphenyl)benzotriazole; benzophenone based ultraviolet ray absorbers such as 2,4-dihydroxybenzophenone, and bis(2-methoxy-4-hydroxy-5-benzoylphenyl)methane; and triazine based ultraviolet ray absorbers such as hydroxyphenyl triazine based ultraviolet ray absorbers such as 2-(2-hydroxy-4-[1-octyloxycarbonylethoxy]phenyl)-(4,6-bis(4-phenylphenyl)-1,3,5-triazine, and 2-[4-[(2-hydroxy-3-dodecyloxypropyl)oxy]-2-hydroxyphenyl]-4,6-bis(2.4-dimethylphenyl)-1,3,5-triazine. Meanwhile, examples of the inorganic based ultraviolet ray absorber may include metal oxide particles such as titanium dioxide, cerium oxide, zirconium oxide, and iron oxide. The average particle size of the metal oxide particles is, for example, 200 nm or less.

Examples of the photostabilizer may include hindered amine based photostabilizers. Examples of the hindered amine based photostabilizer may include bis(1,2,2,6,6-pentamethyl-4-piperidyl) sebacate, and tetrakis(2,2,6,6-tetramethyl-) 4-piperidyl)-1,2,3,4-butanetetracarboxylate.

Examples of the antioxidant may include a phenol based antioxidant, a sulfur based antioxidant, and a phosphorus based antioxidant.

### 2-3. Second Vinyl Chloride Based Resin Layer

The thickness of the second vinyl chloride based resin layer is, for example, 250 μm or less, may be 200 μm or less, and may be 180 μm or less. When the second vinyl chloride based resin layer is thick, the processing suitability in vacuum forming, for example, with respect to a base member including a curved surface portion, may be reduced. Meanwhile the thickness of the second vinyl chloride based resin layer is, for example, 100 μm or more, may be 120 μm or more, and may be 140 μm or more. When the second vinyl chloride based resin layer is thin, the scratch resistance may be reduced. Also, when the thickness of the second vinyl chloride based resin layer is the value described above or more, it is easier to carry out the embossing process, and it is easier to form the convexoconcave shape.

The second vinyl chloride based resin layer preferably has transparency capable of discerning the design layer. Also, the second vinyl chloride based resin layer may have a convexoconcave shape including a convex portion and a concave portion, on a surface protective layer side surface.

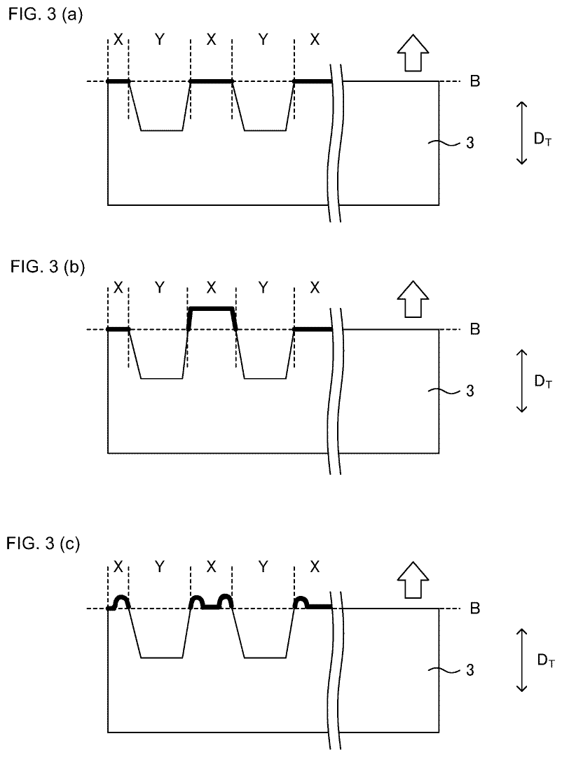

The convex portion and the concave portion of the second vinyl chloride based resin layer are defined as follows. In other words, as shown in FIG. 3(a), among the surface of the second vinyl chloride based resin layer 3 that is opposite to the design layer 2, a surface on which the convexoconcave is not formed is regarded as a reference surface B. The convex portion X refers to a portion located at the same position as the reference surface B and a position protruding from the reference surface B in the thickness direction Dr. The concave portion Y refers to a portion located at a recessed position than the reference surface B in the thickness direction Dr. In FIG. 3(a), every convex portion X includes only a flat surface at the same position as the reference surface B in the thickness direction Dr. Meanwhile, in FIG. 3(b), the convex portion X in the middle protrudes from the reference surface B in the thickness direction Dr. The convex portion X on the left side and the convex portion X on the right side include only a flat surface at the same position as the reference surface B in the thickness direction Dr. Also, in FIG. 3(c), although every convex portion X includes a flat surface at the same position as the reference surface B in the middle, in the thickness direction Dr, the edge portion of the convex portion X protrudes from the reference surface B in the thickness direction Dr.

The convex portion or the concave portion in the second vinyl chloride based resin layer may be disposed corresponding to the pattern of the design layer. When the second vinyl chloride based resin layer has the convexoconcave shape, in addition to the appearance of unevenness, tactile impression and gloss matte impression can be obtained.

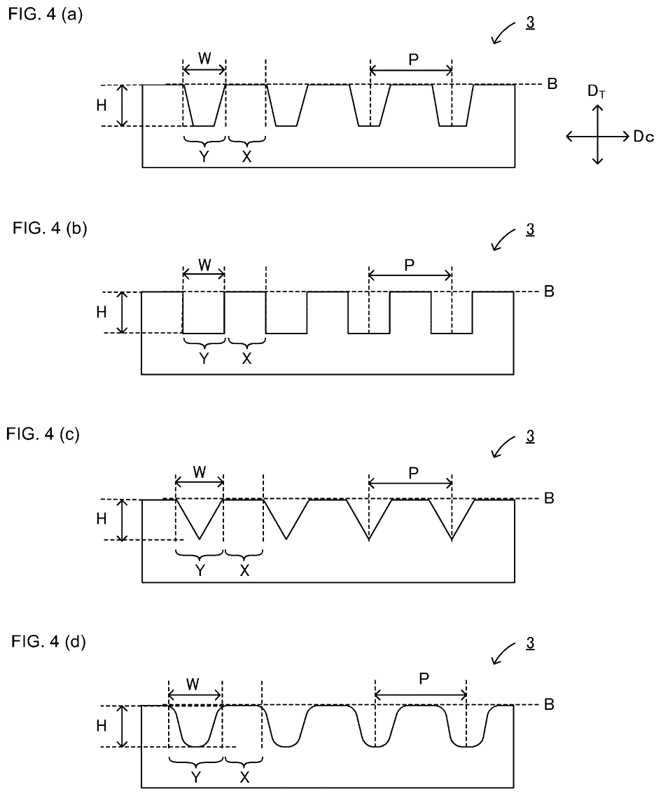

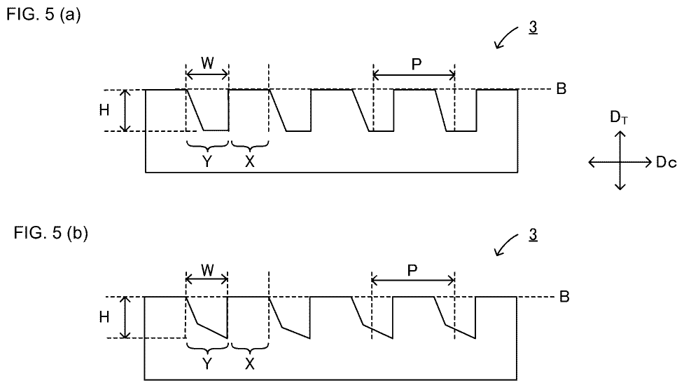

The cross-sectional shape of the concave portion is not particularly limited. FIG. 4 and FIG. 5 are schematic cross-sectional views exemplifying the convexoconcave shape of the second vinyl chloride based resin layer in the present disclosure. As shown in FIG. 4(a), the cross-sectional shape of the concave portion Y of the second vinyl chloride based resin layer 3 may be a pedestal shape. Also, as shown in FIGS. 4(b) to (d), the cross-sectional shape of the concave portion Y of second vinyl chloride based resin layer 3 may be a rectangular shape (FIG. 4(b)), may be a triangular shape (FIG. 4(c)), and may be a shape including a curved corner (such as U-shaped) (FIG. 4(d)). Also, the angle of inclination of the wall surfaces in one concave portion Y may be different from each other (FIG. 5(a)). Also, the bottom surface may be inclined (FIG. 5(b)).

The plan-view shape of the concave portion is not particularly limited. The plan-view shape of the concave portion may be a line form, and may be a dot form. Examples of the plan-view shape of each dot may include a circular shape, an oval shape, a triangular shape, and a rectangular shape. Specific examples of the pattern of the concave portion may include a duct groove of wood-grain plate, a stone plate surface, a cloth surface texture, a pear skin finish, a sand-grain, a hairline, and a hatching-line groove.

As shown in FIG. 4 and FIGS. 5, the width of concave portion Y is regarded as W. The width W may be, for example, 20 μm or more, may be 50 μm or more, and may be 100 μm or more. Meanwhile, the width W is, for example, 1 cm or less, may be 5 mm or less, and may be 2 mm or less. The width W of the concave portion Y is the length of the opening in the concave portion Y (length of the opening in direction Dc orthogonal to the thickness direction Dr).

As shown in FIG. 4 and FIGS. 5, the depth of the concave portion Y is regarded as H. The depth H is, for example, 5 μm or more, may be 10 μm or more, and may be 20 μm or more. Meanwhile, the depth H is, for example, 400 μm or less, may be 300 μm or less, may be 200 μm or less, and may be 100 μm or less. The depth H of the concave portion Y is the maximum distance between the bottom portion of the concave portion Y and the boundary between the concave portion Y and the convex portion X (distance in the thickness direction D_{T}).

Specifically, when the brightness layer described below includes acrylic based resin as the resin component, the depth H of the concave portion Y of the second vinyl chloride based resin layer is preferably, for example, 10 μm or more and 100 μm or less. The reason therefor is to improve the close adhesiveness between the second vinyl chloride based resin layer and the brightness layer while exhibiting the designability.

When the brightness layer described later includes acrylic based resin and vinyl chloride-vinyl acetate copolymer as the resin components, the brightness layer can easily follow the elongation of the second vinyl chloride based resin layer during heating and elongation in vacuum forming. In this case, even when the depth of the concave portion Y of the second vinyl chloride based resin layer is deep, a decorative sheet with good close adhesiveness between the second vinyl chloride based resin layer and the brightness layer. The depth of the concave portion Y in this case may be, for example, 10 μm or more and 400 μm or less, and may be 20 μm or more and 350 μm or less. When the depth is in the above range, it becomes easier to remove stains stuck in the concave portion of the surface of the decorative sheet while exhibiting the designability.

As shown in FIG. 4 and FIGS. 5, the pitch between the adjacent concave portions Y is regarded as P. The pitch P is, for example, 5 μm or more, may be 10 μm or more, and may be 20 μm or more. Meanwhile, the pitch P is, for example, 5 cm or less, may be 1 cm or less, and may be 5 mm or less. The pitch P between adjacent concave portions Y is the center-to-center distance of the adjacent concave portions Y (center-to-center distance in direction D_{c} orthogonal to the thickness direction D_{T}).

Examples of a method for forming a second vinyl chloride based resin layer with a convexoconcave shape on the surface thereof may include the following methods. Examples of the method may include a method wherein a second vinyl chloride based resin layer is firstly lamination formed on the design layer, and a convexoconcave shape (convex portion and concave portion) is formed om the surface that is opposite to the design layer.

The method for forming a convexoconcave shape is not particularly limited, and examples may include an embossing process. In the embossing process, a second vinyl chloride based resin layer including a convexoconcave shape can be obtained by, for example, after heating and softening the second vinyl chloride based resin layer on a heating drum, further heating with an infrared radiation heater, pressurizing, shaping, cooling and fixing with an embossing plate provided with a convexoconcave pattern of a desired shape. The heating temperature is, for example, 80° C. or more and 260° C. or less, may be 85° C. or more and 200° C. or less, and may be 100° C. or more and 180° C. or less. The embossing process can be carried out, for example, using a single-wafer embossing machine or a rotary embossing machine. Also, a method wherein an embossing process is carried out at the same time in the step of stacking the second vinyl chloride based resin layer on the design layer (so-called a doubling embossing method) may be used.

### 3. Design Layer

The design layer in the present disclosure is disposed between the first vinyl chloride based resin layer and the second vinyl chloride based resin layer, and it imparts a designability to the decorative sheet. The design layer may be a single layer, and may be a stacked body of a plurality of layers of the same type of different types. The design layer includes, for example, at least one of a solid layer and a pattern layer, and preferably includes both of the solid layer and the pattern layer. In the present disclosure, the solid layer means a layer formed over the entire surface of one surface of a porous substrate. Also, the patter layer means a layer formed partially (especially in a pattern) on one surface of a porous substrate.

Examples of the pattern (design) in the pattern layer may include wood-grain pattern, stone-grain pattern, sand-grain pattern, tile laying pattern, brick laying pattern, fabric-grain pattern, leather tie-dyed pattern, geometric shapes, letters, symbols, abstract patterns, and plant and flower patterns.

The design layer usually includes a colorant and a binder resin. Examples of the colorant may include inorganic pigments such as carbon black (cake ink), iron black, titanium white, antimony white, lead yellow, titanium yellow, Bengal red, cadmium red, ultramarine blue, and cobalt blue; organic pigments (including dyes) such as quinacridone red, isoindolinone yellow, nickel azo complex, phthalocyanine blue, and azomehineazo black; metallic pigments such as aluminum and brass; and pearl pigments such as titanium dioxide-coated mica, and basic lead carbonate.

The content of the colorant in the design layer is, for example, 0 parts by mass or more, preferably 10 parts by mass or more, and more preferably 20 parts by mass or more, with respect to 100 parts by mass of the binder resin. Meanwhile, the content of the colorant is, for example, 50 parts by mass or less, and preferably 45 parts by mass or less. By setting the ratio in the above range, the design layer can be disposed without deteriorating the close adhesiveness between the first vinyl chloride based resin layer and the second vinyl chloride based resin layer.

Examples of the binder resins may include urethane based resins, acrylic polyol based resins, acrylic based resins, ester based resins, vinyl acetate based resins, amide based resins, butyral based resins, styrene based resins, urethane-acrylic copolymers, vinyl chloride based resins, vinyl chloride-vinyl acetate copolymers, vinyl chloride-vinyl acetate-acrylic copolymers, chlorinated propylene based resins, cellulose nitrate based resins (pyroxylin), cellulose acetate based resins, polyethylene based resins, and polypropylene based resins. The design layer may include only one type of the binder resin, and may include two types or more. The design layer preferably includes an acrylic polyol based resin and a vinyl chloride-vinyl acetate copolymer. The reason therefor is to dispose the design layer without deteriorating the close adhesiveness between the first vinyl chloride based resin layer and the second vinyl chloride based resin layer.

The design layer may include an additive such as an ultraviolet ray absorber, a photostabilizer, a curing agent, a plasticizer, and a catalyst, if necessary. The thickness of the design layer is, for example, 0.5 μm or more and 20 μm or less, may be 1 μm or more and 10 μm or less, and may be 2 μm or more and 5 μm or less. Also, examples of the method for forming a design layer may include a method wherein an ink including a colorant, a binder resin, and a solvent is applied, and then, dried.

### 4. Surface Protective Layer

The decorative sheet for vacuum forming in the present disclosure includes a surface protective layer on a surface of the second vinyl chloride based resin layer that is opposite side to the design layer. By including the surface protective layer, the bleed out of the plasticizer included in the second vinyl chloride based resin layer can be suppressed.

The surface protective layer usually includes a binder resin. A cured product of a curable resin composition (particularly, a cured product of thermosetting resin composition) is preferably included as the binder resin. The thermosetting resin composition is a composition including at least thermosetting resin and is a composition cured by heating. Examples of the thermosetting resin may include acrylic polyol based resins, vinyl chloride based resins, vinyl acetate based resins, (meth)acrylic based resins, urethane based resins, urethane acrylic based resins, phenolic based resins, urea melamine based resins, epoxy based resins, unsaturated polyester based resins, and silicone based resins. Also, the thermosetting resin composition may be one wherein a curing agent such as isocyanate based curing agents and epoxy based curing agents are added to these resins. In the present disclosure, the thermosetting resin composition preferably includes polyvinyl chloride and acrylic polyol based resins. The reason therefor is to improve the heat elongation property in vacuum forming.

The ratio of the binder resin in the surface protective layer is, for example, 70% by mass or more. The surface protective layer may further include at least one of frosting agents (matting agents), antioxidants, photostabilizers, and ultraviolet ray absorbers as additives. Examples of the frosting agent may include silica. Examples of the antioxidants, photostabilizers, and ultraviolet ray absorbers may include ones similar to those exemplified for the second vinyl chloride based resin layer.

The thickness of the surface protective layer is preferably 10 μm or less. When the thickness of the surface protective layer is the above value or less, the processing suitability in vacuum forming is further improved. Meanwhile, the thickness of the surface protecting layer may be 1 μm or more, and may be 3 μm or more.

The surface protective layer in the present disclosure may be disposed on the entire surface of the decorative sheet, and may be disposed on a part of the decorative sheet. Examples of the method for forming a surface protective layer may include a method wherein the surface of a weather resistant layer is coated with a mixture including a resin component and an additive, dried, and cured.

### 5. Brightness Layer

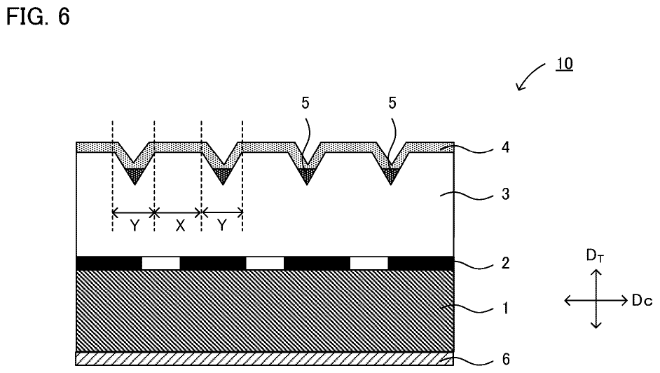

In the present disclosure, as shown in FIG. 6, when the second vinyl chloride based resin layer 3 has a convexoconcave shape including a convex portion X and the concave portion Y on the surface that is opposite to the design layer 2 (the surface protective layer side of the second vinyl chloride based resin layer), the decorative sheet 10 may include a brightness layer 5 including a glittering pigment and a resin component, on a surface of the second vinyl chloride based resin layer 3 that is opposite side to the design layer 2. The brightness layer 5 is disposed in the concave portion Y. In the present disclosure, a high designability can be obtained by combining the design layer and the brightness layer. In a cross-sectional view of the decorative sheet 10 shown in FIG. 6 in the thickness direction Dr, the convex portion X and the concave portion Y are alternately arranged in the direction D_{c} orthogonal to the thickness direction Dr.

Conventionally, the close adhesiveness, to a resin layer, of a brightness layer, formed by filling the concave portion of the resin layer with a glittering ink, is likely to be low than that of a non-brightness layer formed by filling a non-glittering ink. This is because the glittering pigment included in the glittering ink is usually larger in particle size than non-glittering pigment, so that the solvent attacking property to the resin layer is decreased. When such a decorative sheet is used as a decorative sheet for vacuum forming, processing defects such as peeling of the brightness layer, or desorption of the glittering pigment included in the brightness layer may occur during heating and elongation in vacuum forming.

In the present disclosure, a vinyl chloride based resin layer (second vinyl chloride based resin layer) including a vinyl chloride based resin with a higher solvent attacking property, as compared to conventionally used polyolefin based resin, is used as the resin layer having a convexoconcave shape. This makes it easier for the solvents of the glittering ink to penetrate into the second vinyl chloride based resin layer, when the concave portion of the second vinyl chloride based resin layer is filled with the glittering ink, so that the close adhesiveness between the second vinyl chloride based resin layer and the brightness layer is improved.

Further, as described above, in the decorative sheet for vacuum forming in the present disclosure, since the nanoindentation hardness of the first vinyl chloride based resin layer, in a cross-section in a thickness direction, is a predetermined value or less, it has excellent processing suitability. In such a decorative sheet having excellent processing suitability, processing defects such as peeling of the brightness layer, or desorption of the glittering pigment included in the brightness layer may be prevented during heating and elongation in vacuum forming.

Further, the close adhesiveness between the vinyl chloride based resin layer and the brightness layer tends to deteriorate under low temperature environment. This is presumed to be due to the hardening of the vinyl chloride based resin layer under low temperature environment, resulting in a decrease in flexibility. In contrast to this, in the decorative sheet for vacuum forming in the present disclosure, the second vinyl chloride based resin layer includes aliphatic dibasic acid based plasticizer. Therefore, even when the decorative sheet for vacuum forming is transported or stored in low temperature environments such as winter and cold regions, processing defects in vacuum forming can be suppressed.

### (1) Composition of Brightness Layer

The brightness layer includes a glittering pigment, and a resin component.

### (a) Resin

The brightness layer includes a resin component. The resin component is not particularly limited, and it preferably includes acrylic based resins. By including the acrylic based resin, the glittering pigment is sufficiently bound by the resin component even during heating and elongation in vacuum forming, so that the glittering pigment is further unlikely to be desorbed. By using the second vinyl chloride based resin layer with a high solvent attacking property, and by using a brightness layer including the acrylic based resin, the bonding strength between the second vinyl chloride based resin layer, the resin component in the brightness layer, and the glittering pigment included in the brightness layer is improved. Therefore, the close adhesiveness between the brightness layer and the second vinyl chloride based resin layer is improved, and the processing defects such as peeling of the brightness layer, or desorption of the glittering pigment included in the brightness layer in vacuum forming can be further suppressed. Specific examples of the acrylic based resin may preferably include acrylic resins, and acrylic polyol resins. In the present disclosure, the acrylic polyol resin is preferable.

Examples of the acrylic polyol resin may include ones obtained by copolymerizing alkyl(meth)acrylic acid ester and (meth)acrylic acid ester including a hydroxyl group in the molecule. Examples of the alkyl (meth)acrylic acid ester may include methyl(meth)acrylate, ethyl(meth)acrylate, butyl(meth)acrylate, 2-ethylhexyl(meth)acrylate, and octyl(meth)acrylate. Examples of the (meth)acrylic acid ester including a hydroxyl group in the molecule may include 2-hydroxyethyl(meth)acrylate, 2-hydroxybutyl(meth)acrylate, and 2-hydroxy-3-phenoxypropyl(meth)acrylate.

Also, as for the acrylic resin, acrylic resins including at least (meth)acrylic acid ester monomer as a constituent unit are preferable. Specific examples may include homopolymers of (meth)acrylic acid ester monomers; copolymers of two or more different types of (meth)acrylic acid ester monomers; and copolymers of (meth)acrylic acid ester monomers and other monomers. One type of the acrylic resin may be used alone, and two types or more may be used in a combination. Incidentally, in the present specification, “(meth)acrylic” means “acrylic or methacrylic”, and the same shall apply to other similar products.

Preferable examples of the (meth)acrylic acid ester monomer may include methyl(meth)acrylate, ethyl (meth)acrylate, propyl (meth)acrylate, cyclohexyl (meth)acrylate, normal butyl (meth)acrylate, isobutyl (meth)acrylate, secondary butyl (meth)acrylate, tertiary butyl (meth)acrylate, isobornyl (meth)acrylate, 2-methyl-2-adamantyl (meth)acrylate, and 2-ethyl-2-adamantyl (meth)acrylate. Examples of the copolymer of two or more different types of (meth)acrylic acid ester monomers may include copolymers of two types or more (meth)acrylic acid esters selected from those exemplified above, and these copolymers may be random copolymers, and may be block copolymers.

Other monomers forming a copolymer with the (meth)acrylic acid ester monomer are not particularly limited as long as it is capable of being copolymerized with (meth)acrylic acid ester, and preferable examples in the present disclosure may include (meth)acrylic acid, styrene, maleic acid (anhydrous), fumaric acid, divinylbenzene, vinyl biphenyl, vinyl naphthalene, diphenylethylene, vinyl acetate, vinyl chloride, vinyl fluoride, vinyl alcohol, acrylonitrile, acrylic amide, butadiene, isoprene, isobutene, 1-butene, 2-butene, N-vinyl-2-pyrrolidone, dicyclopentadiene, ethylidene norbornene, alicyclic olefin monomers such as norbornenes, vinyl caprolactam, citraconic acid anhydride, maleimides such as N-phenyl maleimide, and vinyl ethers. Incidentally, the copolymer of (meth)acrylic acid esters and other monomers may be random copolymers, and may be block copolymers.

The content of the acrylic based resins included in the brightness layer is, for example, 30 parts by mass or more and 100 parts by mass or less, may be 40 parts by mass or more and 90 parts by mass or less, and may be 50 parts by mass or more and 80 parts by mass or less, with respect to 100 parts by mass of the total amount of the resin components. When the content is in the above range, the bonding strength between the glittering pigment and the resin component is further improved even during heating and elongation in vacuum forming, so that the glittering pigment is further unlikely to be desorbed.

The brightness layer preferably includes a vinyl chloride-vinyl acetate copolymer as the resin component. This is because the brightness layer can easily follow the elongation of the decorative sheet, particularly the second vinyl chloride based resin layer during heating and elongation in vacuum forming so that the processing defects such as peeling of the brightness layer can further be suppressed. Particularly, the brightness layer preferably includes the vinyl chloride-vinyl acetate copolymer in addition to the acrylic based resin described above.

The content of the vinyl chloride-vinyl acetate copolymer included in the brightness layer is, for example, 0 parts by mass or more and 70 parts by mass or less, may be 10 parts by mass or more and 60 parts by mass or less, and may be 20 parts by mass or more and 50 parts by mass or less, with respect to 100 parts by mass of the total amount of the resin components.

The brightness layer may include other resins. Examples of other resins may include urethane based resins, ester based resins, amide based resins, butyral based resins, styrene based resins, urethane-acrylic copolymers, polycarbonate based urethane-acrylic copolymers, vinyl chloride-vinyl acetate copolymers, vinyl chloride-vinyl acetate-acrylic copolymers, chlorinated propylene based resins, cellulose nitrate based resins, cellulose acetate based resins, vinyl acetate based resins, and vinyl chloride resins. The brightness layer may include only one type of the resin, and may include two types or more.

As the resin component, the brightness layer may include a cured product of the resin. Examples of the curing agent may include isocyanate based curing agents, and epoxy based curing agents. The brightness layer preferably includes a cured product of acrylic polyol resin, particularly preferably includes a cured product wherein acrylic polyol resin is cross-linked cured by a curing agent.

The brightness layer preferably includes (i) a copolymer of vinyl chloride resin and vinyl acetate resin (vinyl chloride-vinyl acetate copolymer) and a resin mixture of acrylic polyol resins; or (ii) a cured product wherein acrylic polyol resin is cross-linked cured by a curing agent.

### (b) Glittering Pigment

For glittering pigment, mica (isinglass) whose surface is coated with a thin film of titanium oxide or iron oxide; pearl pigments (pearl gloss pigments) constituted from scale-like foil pieces such as seashells such as pearl oyster, bismuth oxychloride, and basic lead carbonate; or scale-like foil pieces of metals such as aluminum, brass, gold, silver, copper, tin, and nickel; scale-like foil pieces of metal vapor-deposited resin films; and scale-like foil pieces wherein interference luster is exhibited by stacking a plurality of resin films with different refractive index, may be used.

The average particle size of the glittering pigment is not particularly limited, and is, for example, 5 μm or more and 60 μm or less, and may be 5 μm or more and 25 μm or less.

When the brightness layer includes acrylic based resin as the resin component, the average particle size of the glittering pigment is preferably, for example, 25 μm or less, and more preferably 15 μm or less. The reason therefor is to improve the close adhesiveness between the brightness layer and the second vinyl chloride based resin layer. Meanwhile, the average particle size of the glittering pigment in this case may be 5 μm or more, and may be 10 μm or more.

When the brightness layer includes acrylic based resin and vinyl chloride-vinyl acetate copolymer as the resin components, the brightness layer can easily follow the elongation of the decorative sheet, particularly the second vinyl chloride based resin layer during heating and elongation in vacuum forming. Therefore, even when the brightness layer includes glittering pigments with relatively large size, the close adhesiveness between the brightness layer and the second vinyl chloride based resin layer in the decorative sheet will be excellent. Therefore, a decorative sheet, capable of exhibiting sufficiently high brightness, can be obtained. The average particle size of the glittering pigment in this case may be, for example, 60 μm or less, may be 50 μm or less, and may be 30 μm or less. Meanwhile, the average particle size of the glittering pigment may be 5 μm or more, and may be 10 μm or more.

Here, the average particle size of the particles is obtained by observing the surface protective layer side surface of the decorative sheet with an optical microscope, the average of the particle size of 10 glittering pigment particles is regarded as the average particle size.

The content of the glittering pigment in the brightness layer is, for example, more than 0 parts by mass and 100 parts by mass or less, and may be more than 0 parts by mass and 80 parts by mass or less, with respect to 100 parts by mass of the resin component.

When the brightness layer includes acrylic based resin as the resin component, the content of the glittering pigment in the brightness layer is preferably, for example, 60 parts by mass or less, and may be 50 parts by mass or less, with respect to 100 parts by mass of the resin component described below. The reason therefor is to improve the close adhesiveness between the brightness layer and the second vinyl chloride based resin layer. Meanwhile, the content of glittering pigment may be more than 0 parts by mass, and may be 30 parts by mass or more.

Also, when the brightness layer includes acrylic based resin and vinyl chloride-vinyl acetate copolymer as the resin components, the decorative sheet will have good close adhesiveness between the second vinyl chloride based resin layer and the brightness layer, even when the content of the glittering pigment is high, for the same reason. Therefore, a decorative sheet capable of exhibiting sufficiently high brightness can be obtained. The content of the glittering pigment in the brightness layer in this case may be, for example, 80 parts by mass or less, and may be 70 parts by mass or less, with respect to 100 parts by mass of the resin component described below. Meanwhile, the content of glittering pigment may be more than 0 parts by mass, and may be 30 parts by mass or more.

### (c) Others

The brightness layer may include a colorant having no glittering property (non-glittering) and exhibiting a desired hue. Examples of the colorant may include inorganic pigments such as carbon black (cake ink), iron black, titanium white, antimony white, lead yellow, titanium yellow, Bengal red, cadmium red, ultramarine blue, and cobalt blue; and organic pigments or dyes such as quinacridone red, isoindolinone yellow, and phthalocyanine blue. When the brightness layer includes the glittering pigment and the colorant, in addition to obtaining luster such as metallic luster, pearl luster, and similar luster due to the glittering pigment, it exhibits hue due to the colorant, so that is exhibits a designed appearance so-called “color metallic tone” or “color pearl tone”. The content of the colorant in the brightness layer may be selected as appropriate according to the design.

The brightness layer may include an additive. Examples of the additive may include antimicrobials, antivirals, antioxidants, ultraviolet ray absorbers, and photostabilizers.

### (3) Structure of Brightness Layer

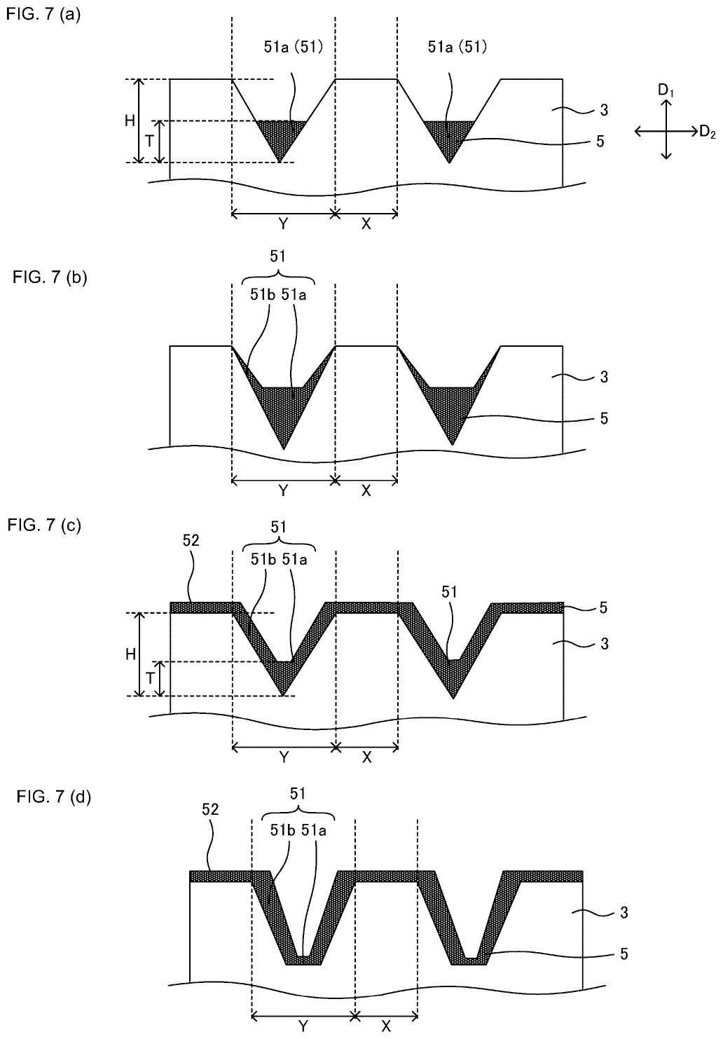

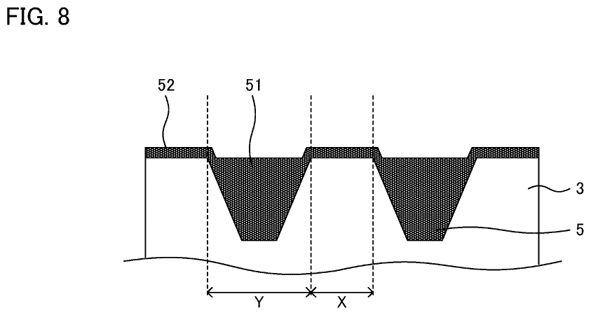

As shown in FIGS. 7(a) to (d) and FIG. 8, the brightness layer 5 is disposed in the concave portion Y. The brightness layer 5 disposed in the concave portion Y may be referred to as a filled portion 51.

As shown in FIG. 7(a), the thickness of the filled portion 51 is regarded as T, and the depth of the concave portion Y of the second vinyl chloride based resin layer 3 is regarded as H. The thickness T is, for example, 1 μm or more, and may be 3 μm or more. Meanwhile, the thickness T is, for example, 100 μm or less, and may be 80 μm or less. Also, the ratio (T/H) of the thickness T with respect to the depth H is, for example, 2% or more, may be 5% or more, and may be 10% or more. Meanwhile, T/H is, for example, 100% or less, may be 50% or less, and may be 30% or less. The smaller the T/H, the more the filled portion not covered by the surface protective layer described below is likely to occur.

As shown in FIG. 7(b), the filled portion 51 may include a bottom surface portion 51a disposed on the bottom surface of the concave portion Y, and a wall surface portion 51b disposed on the wall surface of the concave portion Y. In FIG. 7(b), the bottom surface portion 51a and the wall surface portion 51b are arranged in a continuous manner.

As shown in FIG. 7(c), a part of the brightness layer 5 may be disposed on the convex portion X. A part of the brightness layer 5 disposed on the convex portion X may be referred to as a residue portion 52. The residue portion 52 is disposed between the convex portion X and the surface protective layer (not shown in the figure). Also, the wall surface portion 51b and the residue portion 52 are arranged in a continuous manner. That is, the filled portion 51 and the residue portion 52 are arranged in a continuous manner. Meanwhile, as shown in FIG. 7(b), the residue portion may not be disposed on the convex portion X of the second vinyl chloride based resin layer 3. In this case, the convex portion X and the surface protective layer (not shown in the figure) are disposed not via the residue portion. The convex portion X and the surface protective layer may be disposed so as to be in contact with each other, and may be disposed via, for example, a primer layer.

As shown in FIG. 7(c), the bottom surface portion 51a and the wall surface portion 51b may be of the same thickness. Being of the same thickness means that the difference in thickness between the two is 3 μm or less. Meanwhile, as shown in FIG. 7(b), the thickness of the bottom surface portion 51a may be more than the thickness of the wall surface portion 51b. Also, as shown in FIG. 7(d), the thickness of the bottom surface portion 51a may be less than the thickness of the wall surface portion 51b. The difference in thickness between the two is usually more than 3 μm. Also, as shown in FIG. 7(a), the filled portion 51 may include the bottom surface portion 51a, and may not include the wall surface portion 51b. Also, as shown in FIG. 8, the filled portion 51 may fill the concave portion Y completely, and as shown in FIG. 7(a), the filled portion 51 may not fill the concave portion Y completely.

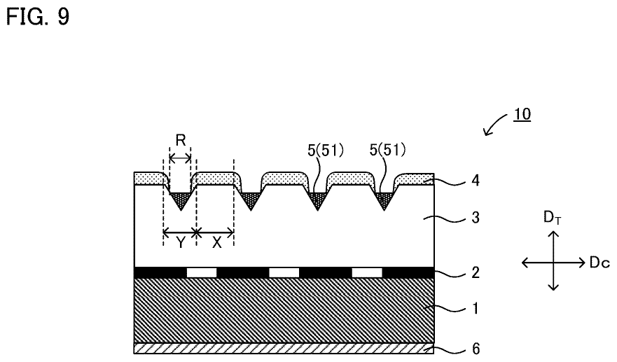

As shown in FIG. 9, when the decorative sheet in the present disclosure includes a brightness layer, the surface protective layer 4 may be disposed on a part of the decorative sheet 10. In this case, the surface protective layer 4 in the present disclosure may include a portion not covering the surface of the filled portion 51. Usually, this portion may be a portion formed intentionally, and may be a portion formed unintentionally.

The surface protective layer is usually disposed on the entire surface of the decorative sheet. However, when the surface protective layer is disposed in the filled portion, the effect of improving the designability by the filled portion is inhibited by the surface protective layer so that the effect may not be fully exhibited. By including the filled portion not covered by the surface protective layer, the effect of improving designability by the filled portion is well exhibited in the decorative sheet.

Here, the condition of the filled portion in the concave portion is observed by a cross-sectional observation of the decorative sheet. The filled portion wherein the entire thereof is covered by the surface protective layer (the filled portion completely covered by the surface protective layer) is regarded as a filled portion A, and the number of filled portion A is designated as N₁; and the filled portion wherein at least a part of the filled portion is not covered by the surface protective layer is regarded as a filled portion B, and the number of filled portion B is designated as N₂.

In the present disclosure, a filled portion B may be included. The ratio of such filled portion B, that is, N₂/(N₁+N₂), may be 10% or more, may be 30% or more, and may be 50% or more. Meanwhile, N₂/(N₁+N₂) may be 100%, and may be less than 100%. In the latter case, N₂/(N₁+N₂) may be 90% or less. For example, depending on the pattern of the design layer, it may be difficult to produce the filled portion not covered by the surface protective layer as intended.

The measurement of N₁ and N₂ is carried out by observing the cross-section as follows. The number of the samples is 10 or more, may be 30 or more, may be 50 or more, and may be 100 or more. The larger the number of samples, the better the accuracy. When selecting measurement points, attention should be paid to avoiding bias as much as possible.

### <Method for Observing Cross-Section>

The observation portion is cut out from the decorative sheet, embedded in photocurable resin, and then, a cross-sectional is prepared using microtome (diamond knife specification, 0.2 μm cutting finish). The prepared cross section is observed using SEM (S-4800 TYPE 2 from Hitachi High-Tech Corporation) at an acceleration voltage of 3.0 kV, a current of 20 μA, and a magnification of 5000-fold.

As shown in FIG. 9, the width of the portion where the filled portion 51 is exposed from the surface protective layer 4 is regarded as R. The width R may be, for example, 10 μm or more, may be 50 μm or more, and may be 100 μm or more. Meanwhile, the width R is, for example, 1 cm or less, may be 5 mm or less, and may be 2 mm or less. The width R is the length of the portion where the filled portion 51 is exposed from the surface protective layer 4 (length of the portion in direction D_{c} orthogonal to the thickness direction D_{T}).

In the present disclosure, a primer layer may or may not be disposed between the second vinyl chloride based resin layer and the brightness layer. In the present disclosure, since the brightness layer includes the resin component described above, the close adhesiveness between the second vinyl chloride based resin layer and the brightness layer is excellent in the decorative sheet, even not via the primer layer.

### 6. Other Layers

The decorative sheet for vacuum forming in the present disclosure may include a primer layer (rear surface primer layer) on the surface of the first vinyl chloride based resin layer that is opposite side to the design layer. By providing the rear surface primer layer, the close adhesiveness between the first vinyl chloride based resin layer and the base member, via the adhesive layer described below, in vacuum forming can be improved.

The primer layer includes at least a binder resin. Examples of the binder resin may include urethane based resins, acrylic polyol based resins, acrylic based resins, ester based resins, amide based resins, butyral based resins, styrene based resins, urethane-acrylic copolymers, polycarbonate based urethane-acrylic copolymers, vinyl chloride-vinyl acetate copolymers, vinyl chloride-vinyl acetate-acrylic copolymers, chlorinated propylene based resins, and cellulose reins. Examples of the cellulose resin may include cellulose nitrate based resins, and cellulose acetate based resins. The primer layer may include only one type of the resin, and may include two types or more. In terms of the close adhesiveness with the adhesive layer, the primer layer preferably includes urethane based resin.

The primer layer may include a cured product of the binder resin. Examples of the curing agent may include isocyanate based curing agents, and epoxy based curing agents.

The primer layer can be formed by coating the rear surface (the surface that is opposite to the design layer) of the first vinyl chloride based resin layer with a primer agent. Examples of the primer agent may include urethane resin based primer agents including acrylic modified urethane resins; and primer agents including urethane-cellulose based resins (such as resins obtained by adding hexamethylene diisocyanate to a mixture of urethane and pyroxylin. The thickness of the primer layer is not particularly limited, and it is preferably, for example, 0.5 μm or more and 2.0 μm or less. By setting the thickness of the primer layer to the thickness described above or more, close adhesiveness with the adhesive layer described later is improved. The occurrence of blocking can be suppressed by setting the thickness to the thickness described above or less.

The primer layer preferably includes inorganic particles such as silica. The reason therefor is to suppress the blocking when unwinding the decorative sheet. Incidentally, blocking is a phenomenon wherein the film rolled up in a form of a roll is difficult to separate from each other when they are unwound afterwards.

### 7. Decorative Sheet for Vacuum Forming

As shown in FIG. 2, the decorative sheet for vacuum forming may have a convexoconcave shape on a surface protective layer 4 side outermost surface, based on the first vinyl chloride based resin layer 1. The convexoconcave shape of the outermost surface of this decorative sheet for vacuum forming may remain within the surface protective layer 4, and may extend to the second vinyl chloride based resin layer 3. By including the convexoconcave shape, in addition to the appearance of unevenness, tactile impression and gloss matte impression can be obtained.

The depth of the convexoconcave shape of the outermost surface of the decorative sheet for vacuum forming is preferably 10 μm or more, and 400 μm or less. In the present disclosure, as shown in FIG. 2, the depth H10 of the convexoconcave shape is the difference between the distance L1 to the farthest portion in the convexoconcave shape X and the distance L2 to the nearest portion in the convexoconcave shape X, along the thickness direction, based on the design layer 2 side surface of the second vinyl chloride based resin layer 3. When the depth of the convexoconcave shape is in the above range, it is easier to remove stains stuck in the concave portion of the surface of the decorative sheet. Examples of the pattern of the convexoconcave shape may include a duct groove of wood-grain plate, a stone plate surface convexoconcave, a cloth surface texture, a pear skin finish, a sand-grain, a hairline, and a hatching-line groove.

Examples of the method for forming the convexoconcave shape of the outermost surface of a decorative sheet for vacuum forming may include a method wherein a decorative sheet for vacuum forming is heated, and pressing an embossing plate. The heating temperature of the stacked sheet is, for example, 80° C. or more and 260° C. or less, may be 85° C. or more and 200° C. or less, and may be 100° C. or more and 180° C. or less.

Also, in the process of producing a decorative sheet, as described later, when a transparent film, which is the second vinyl chloride based resin layer, is adhered to the surface of the design layer that is opposite to the first vinyl chloride based resin layer, the convexoconcave shape may be shaped on the surface the second vinyl chloride based resin layer that is opposite to the design layer, by pressing an embossing plate at the same time as adhering, and then, a surface protective layer may be formed.

### B. Method for Producing Decorative Sheet for Vacuum Forming

The present disclosure provides a method for producing a decorative sheet for vacuum forming, the method comprising: a design layer forming step of forming a design layer on one surface of a first vinyl chloride based resin layer; a disposing step of disposing a second vinyl chloride based resin layer on a surface of the design layer that is opposite side to the first vinyl chloride based resin layer; and a surface protective layer forming step of forming a surface protective layer on a surface of the second vinyl chloride based resin layer that is opposite side to the design layer, wherein the first vinyl chloride based resin layer and the second vinyl chloride based resin layer respectively include vinyl chloride based resin and aliphatic dibasic acid based plasticizer; a nanoindentation hardness of the first vinyl chloride based resin layer, in a cross-section in a thickness direction, is 160 MPa or less; and a nanoindentation hardness of the second vinyl chloride based resin layer, in a cross-section in a thickness direction, is 165 MPa or more. After the disposing step and before the surface protective layer forming step, the method for producing a decorative sheet for vacuum forming in the present disclosure preferably includes an embossing process step, and a brightness layer forming step described later.

### 1. Design Layer Forming Step

In the present step, a design layer is formed on one surface of a first vinyl chloride based resin layer. The first vinyl chloride based resin layer is similar to the contents for the first vinyl chloride based resin layer described above. The method for forming a design layer is similar to the method for forming a design layer described above.

### 2. Disposing Step

In the present step, the second vinyl chloride based resin layer is disposed on a surface of the design layer that is opposite side to the first vinyl chloride based resin layer. The second vinyl chloride based resin layer is similar to the contents for the second vinyl chloride based resin layer described above. The design layer and the second vinyl chloride based resin layer may be adhered by a heat lamination. Also, an adhesive layer may or may not be disposed between the design layer and the second vinyl chloride based resin layer.

### 3. Embossing Process Step and Brightness Layer Forming Step

### (1) Embossing Process Step

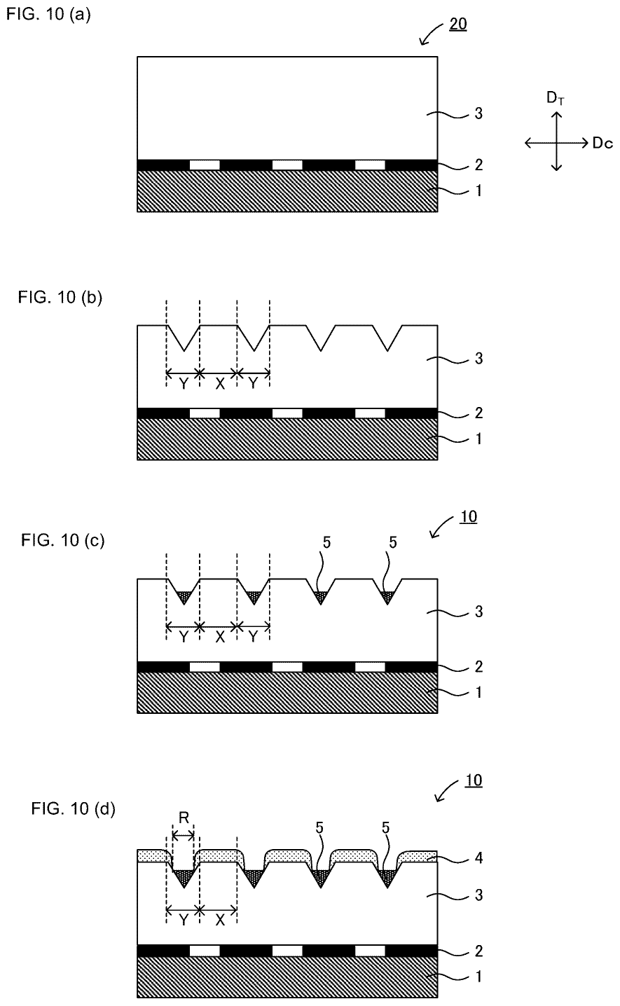

As shown in FIGS. 10, the method for producing a decorative sheet for vacuum forming in the present disclosure preferably includes an embossing process step (FIG. 10(b) of forming a convexoconcave shape including a convex portion X and a concave portion Y, to the stacked body 20 obtained in the disposing step (FIG. 10(a)) described above, by subjecting a surface of the second vinyl chloride based resin layer 3, that is opposite side to the design layer 2, to an embossing process. The present step may be carried out at the same time as the disposing step described above. The method for an embossing process is as described above.

### (2) Brightness Layer Forming Step

After the embossing process step, as shown in FIG. 10(c), the method for producing a decorative sheet for vacuum forming in the present disclosure may include a brightness layer forming step of forming a brightness layer 5 by filling the concave portion with a glittering ink by applying the glittering ink to a surface of the second vinyl chloride based resin layer 3, and wiping.

The glittering ink used for forming the brightness layer preferably includes the glittering pigment described above and a resin with glass transition temperature higher than 70° C. Examples of the resin with glass transition temperature higher than 70° C. may include acrylic based resin described above, and particularly preferably acrylic polyol resins. By using the resin with glass transition temperature higher than 70° C. for the glittering ink, the glittering pigment is sufficiently bound by the resin component even during heating and elongation in vacuum forming, so that the glittering pigment is further unlikely to be desorbed. By using the second vinyl chloride based resin layer with a high solvent attacking property, and by using a brightness layer including the resin with glass transition temperature higher than 70° C., the bonding strength between the second vinyl chloride based resin layer, the resin component included in the brightness layer, and glittering pigment included in the brightness layer is improved. Therefore, the close adhesiveness between the brightness layer and the second vinyl chloride based resin layer is improved, and the processing defects such as peeling of the brightness layer, or desorption of the glittering pigment included in the brightness layer in vacuum forming can be further suppressed.

Also, it is preferable that the glittering ink further includes a resin with glass transition temperature of 70° C. or less. As the resin with glass transition temperature of 70° C. or less, a vinyl chloride-vinyl acetate copolymer is preferable. By using the resin with glass transition temperature of 70° C. or less for the glittering ink, it is possible to obtain a decorative sheet highly flexible during heating and elongation in vacuum forming, and capable of easily following the elongation of the second vinyl chloride based resin layer.

As the resin composition, the glittering ink preferably uses a copolymer of vinyl chloride resin and vinyl acetate resin (vinyl chloride-vinyl acetate copolymer) and a mixture resin of acrylic polyol resins.

The glittering ink usually includes a solvent. Examples of the solvent included in the glittering ink may include petroleum based organic solvents such as hexane, heptane, octane, toluene, xylene, ethylbenzene, cyclohexane, and methylcyclohexane; ester based organic solvent such as ethyl acetate, butyl acetate, isobutyl acetate, 2-methoxyethyl acetate, and 2-ethoxyethyl acetate; alcoholic based organic solvents such as methyl alcohol, ethyl alcohol, normal propyl alcohol, isopropyl alcohol, isobutyl alcohol, ethylene glycol, and propylene glycol; ketone base organic solvents such as acetone, methyl ethyl ketone, methyl isobutyl ketone, and cyclohexanone; ether based organic solvents such as diethyl ether, dioxane, and tetrahydrofuran; chloride based organic solvents such as dichloromethane, carbon tetrachloride, trichloroethylene, and tetrachloroethylene; and inorganic solvents such as water. One type of the solvent or dispersing medium may be used alone, and two types or more may be used in a combination. In the present disclosure, for example, methyl ethyl ketone, ethyl acetate, butyl acetate, and isobutyl acetate are preferable. This is because the solvent attacking property with respect to the second vinyl chloride based resin layer is high.

### 4. Surface Protective Layer Forming Step

In the present step, a surface protective layer is formed on the surface of the second vinyl chloride based resin layer that is opposite side to the design layer. At this time, it is preferable to form the surface protective layer so that the brightness layer (filled portion) is not covered. The method for forming the surface protective layer is as described above. Prior to the surface protective layer forming step, a primer layer forming step may be carried out.

### C. Decorative Member

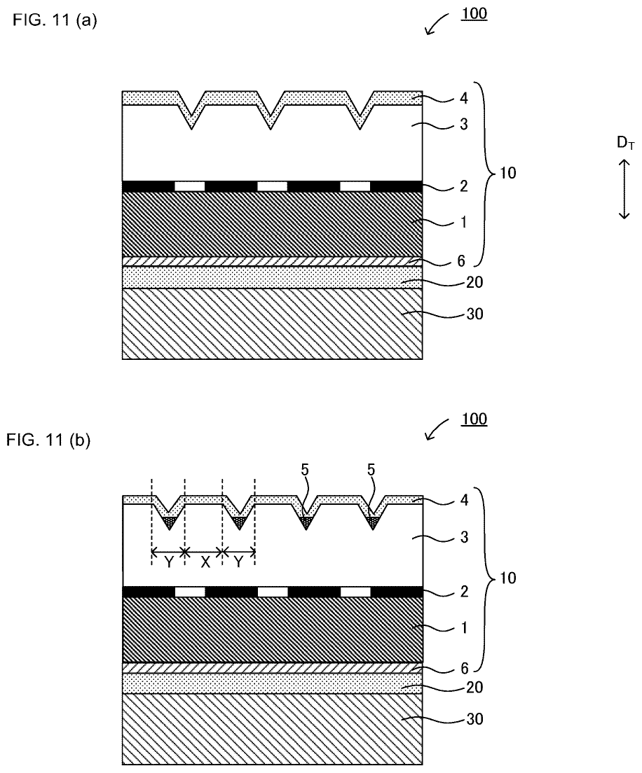

The present disclosure provides a decorative member comprising a base member and the decorative sheet for vacuum forming described above. FIGS. 11(a) and (b) are schematic cross-sectional views exemplifying the decorative member in the present disclosure. In the decorative member 100 shown in FIGS. 11(a) and (b), base member 30 and the decorative sheet for vacuum forming 10 are closely adhered via an adhesive layer 20, and the decorative sheet for vacuum forming 10 is disposed so that the first vinyl chloride based resin layer 1 is on the base member 30 side, based on the design layer 2 of the decorative sheet for vacuum forming 10. The decorative sheet for vacuum forming 10 shown in FIG. 11(a) includes a rear surface primer layer 6, a first vinyl chloride based resin layer 1, a design layer 2, a second vinyl chloride based resin layer 3, and a surface protective layer 4 in this order, in a thickness direction D_{T}, The decorative sheet for vacuum forming 10 shown in FIG. 11(b) includes a rear surface primer layer 6, a first vinyl chloride based resin layer 1, a design layer 2, a second vinyl chloride based resin layer 3, a brightness layer 5, and a surface protective layer 4 in this order, in a thickness direction D_{T},

According to the present disclosure, since the decorative sheet for vacuum forming described above is included, the possibility of occurrence of the processing defects in vacuum forming is low, and a decorative member with high scratch resistance may be obtained.

### 1. Decorative Sheet for Vacuum Forming

Since the decorative sheet for vacuum forming in the present disclosure is similar to the content described in “A. Decorative sheet for vacuum forming” above, the description herein is omitted.

### 2. Base Member

The base member in the present disclosure is a member decorated by the decorative sheet for vacuum forming. Examples of the base member may include a resin member. Examples of the resin used for the resin member may include vinyl chloride based resins, acrylic based resins, ester based resins, styrene based resins, olefin based resins, acrylonitrile-butadiene-styrene based copolymers (ABS based resins), phenolic based resins, cellulose based resins and rubber. Also, other examples of the base member may include a woody member. Examples of the woody member may include wood single panel, plywood panel, particle board, and woody fiberboard. Examples of the wood used for the woody member may include cedar, hinoki cypress, pine, and lauan.

Also, other examples of the base member may include a metal member. Examples of the metal used for the metal member may include iron, and aluminum. Also, other examples of the base member may include a ceramic member. The material of the ceramic member may be ceramics such as glass and pottery, may be non-cement ceramic materials such as gypsum, and may be non-pottery ceramic materials such as ALC (lightweight aerated concrete).

The shape of the base member is not particularly limited, and examples may include a plate shape, a sheet shape, and a steric shape, and a three dimensional steric shape is preferable. Also, the base member may include a flat surface portion, may include a curved surface portion, and may include both the flat surface portion and the curved surface portion. Also, the base member may include at least one of a convex portion, a concave portion, a convexity portion, a concavity portion, and a through portion.

### 3. Adhesive Layer

The decorative member in the present disclosure may include an adhesive layer between the base member and the decorative sheet for vacuum forming. The adhesive used for the adhesive layer is not particularly limited, and commonly known adhesives can be used. Examples thereof may include adhesives such as heat-sensitive adhesives and pressure-sensitive adhesives. Examples of the resin used for the adhesives may include acrylic based resins, urethane based resins, vinyl chloride based resins, vinyl acetate based resins, ester based resins, amide based resins, vinyl chloride-vinyl acetate copolymer, and styrene-acrylic copolymer. Also, as the adhesive, two-component curing type polyurethane based adhesives using an isocyanate compound as a curing agent, and polyester based adhesives can also be used.

The thickness of the adhesive layer in the present disclosure is usually 2 μm or more and 35 μm or less, and may be 5 μm or more and 30 μm or less.

### 4. Decorative Member

The decorative member in the present disclosure may be used for various purposes, such as interior or exterior materials of buildings such as walls, ceilings, and floors; surface decorative panels of joinery such as window frames, doors, handrails, skirting boards, ceiling cornices, and malls; surface decorative panels of cabinets such as kitchens, furniture, or light electrical appliances, office automation equipment; and interior or exterior of vehicles.

The method for producing a decorative member in the present disclosure is not particularly limited. Examples of the method for producing a decorative member may include methods including a preparing step of preparing a base member and the decorative sheet for vacuum forming described above; a softening step of softening the decorative sheet for vacuum forming by heating; and a vacuum adsorbing step of vacuum adsorbing the softened decorative sheet for vacuum forming to the shape of the base member by a depressurizing operation. In the softening step, in order to adjust the pressure, the decorative sheet after forming is elongated as a whole than before the forming. In the softening step, the decorative sheet is preferably softened by heating the decorative sheet to a temperature higher than 70° C., for example, usually approximately 80° C. or more and 130° C. or less, preferably approximately 90° C. or more and 120° C. or less. In the vacuum adsorbing step, an adhesive layer is preferably disposed between the base member and the decorative sheet for vacuum forming.

The present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

### (Production of Decorative Sheet for Vacuum Forming)

A colored substrate film with a thickness of 100 μm (first vinyl chloride based resin layer) including a vinyl chloride based resin and a plasticizer (diisononyl adipate) was prepared. In the first vinyl chloride based resin layer, the compounded amount of the plasticizer (diisononyl adipate), with respect to 100 parts by mass of the vinyl chloride based resin was 10 parts by mass. Then, a stone-grain design pattern was gravure printed on one surface of the first vinyl chloride based resin layer, with an ink including acrylic vinyl chloride acetate resin, to form a design layer. A transparent resin film with a thickness of 200 μm (second vinyl chloride based resin layer) including a vinyl chloride based resin and a plasticizer (diisononyl adipate) was adhered to the surface of the design layer that was opposite to the first vinyl chloride based resin layer, by a thermal lamination embossing method. At the time of the thermal lamination, using an embossing plate with a plate depth of 130 μm produced by a laser engraving method, a stone-grain tone convexoconcave pattern was shaped on the second vinyl chloride based resin layer side surface. In the second vinyl chloride based resin layer, the compounded amount of the plasticizer (diisononyl adipate), with respect to 100 parts by mass of the vinyl chloride based resin was 4 parts by mass. A surface protective layer including vinyl chloride modified acrylic polyol resin was formed on the surface of the second vinyl chloride based resin layer that was opposite side to the design layer. Also, using a primer agent including urethane based resin and pyroxylin resin, a rear surface primer layer was formed on the surface (rear surface) of the first vinyl chloride based resin layer that was opposite side to the design layer. Thereby, a decorative sheet for vacuum forming including a rear surface primer layer, a first vinyl chloride based resin layer, a design layer, a second vinyl chloride based resin layer, and a surface protective layer in this order, in a thickness direction, was produced.

### Example 2

A decorative sheet for vacuum forming was produced in the same manner as in Example 1 except that the compounded amount of the plasticizer (diisononyl adipate) in the first vinyl chloride based resin layer, with respect to 100 parts by mass of the vinyl chloride based resin, was changed to 12 parts by mass, and the compounded amount of the plasticizer (diisononyl adipate) in the second vinyl chloride based resin layer, with respect to 100 parts by mass of the vinyl chloride based resin, was changed to 3 parts by mass.

### Comparative Example 1

A decorative sheet for vacuum forming was produced in the same manner as in Example 1 except that the compounded amount of the plasticizer (diisononyl adipate) in the first vinyl chloride based resin layer, with respect to 100 parts by mass of the vinyl chloride based resin, was changed to 7 parts by mass, and the compounded amount of the plasticizer (diisononyl adipate) in the second vinyl chloride based resin layer, with respect to 100 parts by mass of the vinyl chloride based resin, was changed to 2 parts by mass.

### Comparative Example 2

A decorative sheet for vacuum forming was produced in the same manner as in Example 1 except that the compounded amount of the plasticizer (diisononyl adipate) in the first vinyl chloride based resin layer, with respect to 100 parts by mass of the vinyl chloride based resin, was changed to 2 parts by mass, and the compounded amount of the plasticizer (diisononyl adipate) in the second vinyl chloride based resin layer, with respect to 100 parts by mass of the vinyl chloride based resin, was changed to 3 parts by mass.

### Comparative Example 3

A decorative sheet for vacuum forming was produced in the same manner as in Example 1 except that the compounded amount of the plasticizer (diisononyl adipate) in the first vinyl chloride based resin layer, with respect to 100 parts by mass of the vinyl chloride based resin, was changed to 12 parts by mass, and the compounded amount of the plasticizer (diisononyl adipate) in the second vinyl chloride based resin layer, with respect to 100 parts by mass of the vinyl chloride based resin, was changed to 12 parts by mass.

### Comparative Example 4

A decorative sheet for vacuum forming was produced in the same manner as in Example 1 except that the compounded amount of the plasticizer (diisononyl adipate) in the first vinyl chloride based resin layer, with respect to 100 parts by mass of the vinyl chloride based resin, was changed to 28 parts by mass, and the compounded amount of the plasticizer (diisononyl adipate) in the second vinyl chloride based resin layer, with respect to 100 parts by mass of the vinyl chloride based resin, was changed to 25 parts by mass.

### [Measurement of Nanoindentation Hardness]

The nanoindentation hardness of the first vinyl chloride based resin layer and the second vinyl chloride based resin layer of the decorative sheet for vacuum forming obtained above was measured by the method described above.

### [Evaluation]

### (Processing Suitability in Vacuum Forming)

A decorative member was obtained by heating the decorative sheet obtained above to soften it, and vacuum adsorbing to the shape of the base member by a depressurizing operation. The condition of the decorative sheet of the obtained decorative member was visually observed and evaluated according to the following evaluation criteria. The results are shown in Table 1.

### Evaluation Criteria

A: The decorative sheet follows the shape of the base member, and the process was carried out without cracking the surface of the decorative sheet.

B: The decorative sheet does not follow the shape of the base member, or a defect such as a crack in the surface of the decorative sheet occurred during the process.

### (Scratch Resistant)

1) Scratch Test with Hoffmann Scratch Tester (Test 1)

The surface protective layer side surface of the decorative sheet for vacuum forming produced above was scratched using a Hoffman scratch tester. The load at the time when a change occurred in the gloss was measured. The results are shown in Table 1.

2) Scratch Test with Nail (Test 2)

The surface protective layer side surface of the decorative sheet for vacuum forming produced above was scratched with a nail for 5 strokes, and the change in the gloss of appearance was compared. The results evaluated by the following evaluation criteria are shown in Table 1.
Evaluation criteria
A: Slight gloss change occurred.
B: Significant gloss change occurred.
C: Bleaching scar occurred.

TABLE 1

| | | | | | Comp. | Comp. | Comp. | Comp. |
|---|---|---|---|---|---|---|---|---|
| | | | Ex. 1 | Ex. 2 | Ex. 1 | Ex. 2 | Ex. 3 | Ex. 4 |
| Nano- | First vinyl | | 150 | 120 | 175 | 230 | 120 | 30 |
| indentation | chloride based | | | | | | | |
| hardness | resin layer | | | | | | | |
| [MPa] | Second vinyl | | 180 | 190 | 200 | 190 | 100 | 45 |
| | chloride based | | | | | | | |
| | resin layer | | | | | | | |
| Evaluation | Vacuum | | A | A | B | B | A | A |
| | forming | | | | | | | |
| | processing | | | | | | | |
| | suitability | | | | | | | |
| | Scratch | Test 1 | 50 g | 50 g | 75 g | 75 g | 25 g | 25 g |
| | resistance | | | | | | | Bleaching |
| | | | | | | | | scar |
| | | | | | | | | occurred |
| | | Test 2 | A | A | A | A | B | C |
| | | Overall | A | A | A | A | B | C |

As shown in Table 1, it was confirmed that the decorative sheets in Example 1 and Example 2 in the present disclosure had good processing suitability in vacuum forming and had high scratch resistance.

### Example 3

### (Production of Decorative Sheet)

A colored substrate film with a thickness of 100 μm (first vinyl chloride based resin layer) including a vinyl chloride based resin and a plasticizer (diisononyl adipate) was prepared. In the first vinyl chloride based resin layer, the compounded amount of the plasticizer (diisononyl adipate), with respect to 100 parts by mass of the vinyl chloride based resin, was 10 parts by mass. Then, a stone-grain design pattern was gravure printed on one surface of the first vinyl chloride based resin layer, with an ink including acrylic vinyl chloride acetate resin, to form a design layer. A transparent resin film with a thickness of 200 μm (second vinyl chloride based resin layer) including a vinyl chloride based resin and a plasticizer (diisononyl adipate) was adhered to the surface of the design layer that was opposite to the first vinyl chloride based resin layer, by a thermal lamination embossing method. At the time of the thermal lamination, using an embossing plate produced by a laser engraving method, a stone-grain tone convexoconcave pattern was shaped on the second vinyl chloride based resin layer side surface. The depth of the concave portion was 360 μm. In the second vinyl chloride based resin layer, the compounded amount of the plasticizer (diisononyl adipate), with respect to 100 parts by mass of the vinyl chloride based resin, was 4 parts by mass. The following ink for a brightness layer was supplied to the surface of the second vinyl chloride based resin layer (surface with a convexoconcave shape), then, a doctor blade was pressed perpendicular to the substrate layer, scraped the ink for a brightness layer, pressed the ink into the concave portion of the resin layer, and excess ink was removed. Then, the ink was dried and cured to form a brightness layer. A surface protective layer including vinyl chloride modified acrylic polyol resin was formed on the surface of the second vinyl chloride based resin layer that was opposite side to the design layer. Thereby, a decorative sheet was produced.

The nanoindentation hardness of the first vinyl chloride based resin layer and the second vinyl chloride based resin layer was 150 MPa and 180 MPa, respectively.

### <Ink for Brightness Layer>

### Composition for Resin 1

Acrylic polyol 50 parts by mass
Vinyl chloride-vinyl acetate copolymer 50 parts by mass

### Glittering Pigment

Pearl pigment (particle size of 5 μm to 25 μm, average particle size of 11 μm) 42 parts by mass with respect to 100 parts by mass of the composition for resin

### Solvent (Methyl Ethyl Ketone) 460 Parts by Mass

### Example 4 to Example 11

A decorative sheet was produced in the same manner as in Example 3 except that the depth of the concave portion of the second vinyl chloride based resin layer, and the particle size and the compounded amount of the pearl pigment in the ink for a brightness layer, and the composition for resin in the ink for a brightness layer were changed to those shown in Table 2. Incidentally, the compounded amount of the pearl pigment in Table 2, when the composition for resin 1 was used, was a ratio with respect to 100 parts by mass of the total amount of the acrylic polyol and vinyl chloride-vinyl acetate copolymer. The compounded amount of the pearl pigment in Table 2, when the composition for resin 2 was used, was a ratio with respect to 100 parts by mass of the content of acrylic polyol.

In Table 2, the composition for resin 2 was as follows.

### Composition for Resin 2

Acrylic polyol 100 parts by mass

### Curing Agent (Polyisocyanate) 34 Parts by Mass

### Comparative Example 5

A decorative sheet for vacuum forming was produced in the same manner as in Example 3 except that a transparent resin layer including polypropylene resin (PP) was used as the second vinyl chloride based resin layer, the depth of the concave portion of the second vinyl chloride based resin layer, and the particle size and the compounded amount of the pearl pigment in the ink for a brightness layer, and the composition for resin in the ink for a brightness layer were changed to those shown in Table 2.

### [Evaluation]

(Evaluation of Close Adhesiveness after Heating and Elongation)

A sample was cut out from the decorative sheet obtained above, and lines were drawn on the sample at intervals of 5 cm, and the sample was elongated, in a constant temperature bath at 70° C., so that the distance between lines was 10 cm or more and 11 cm or less. A 60 mm long cellophane tape (24 mm wide, from Nichiban Co., Ltd.) was closely adhered to the surface of the elongated sample that was opposite to the substrate film, and the tape was rapidly peeled off at an angle of 45°. The ratio (S2/S1) of the area S2 where the pearl is adhered, with respect to the area S1 (60 mm×24 mm) of the closely adhered and peeled Sellotape (registered trademark) was calculated. This was repeated for 10 times, the arithmetic average value of 10 times was obtained, and evaluated according to the following evaluation criteria.

### Evaluation Criteria

S: 0% or more and 5% or less
A: more than 5% and 20% or less
B: more than 20% and 40% or less
C: more than 40% and 60% or less
D: more than 60% and 80% or less
E: more than 80% and 100% or less

TABLE 2

| | | | | | | | | | | | | Comp. |
|---|---|---|---|---|---|---|---|---|---|---|---|---|
| | | | Example | | | | | | | | | Ex. |
| | | | 3 | 4 | 5 | 6 | 7 | 8 | 9 | 10 | 11 | 5 |
| Substrate | | | Vinyl chloride resin | | | | | | | | | PP |
| Transparent | Concave portion | | 360 | 80 | 80 | 80 | 20 | 360 | 80 | 80 | 80 | 20 |
| resin layer | depth [μm] | | | | | | | | | | | |
| Brightness | Composition for | | Compo- | Compo- | Compo- | Compo- | Compo- | Compo- | Compo- | Compo- | Compo- | Compo- |
| Layer | resin | | sition 1 | sition 1 | sition 1 | sition 2 | sition 2 | sition 2 | sition 2 | sition 2 | sition 1 | sition 2 |
| | Pearl | Particle | 5~25 | 10~60 | 5~25 | 5~25 | 5~25 | 5~25 | 5~25 | 10~60 | 10~60 | 5~25 |
| | pigment | size [μm] | | | | | | | | | | |
| | | Ave. particle | 11 | 22 | 11 | 11 | 11 | 11 | 11 | 22 | 22 | 11 |
| | | size [μm] | | | | | | | | | | |
| | | Amount | 42 | 57 | 83 | 42 | 63 | 63 | 83 | 44 | 83 | 42 |
| | | [pts, mass] | | | | | | | | | | |

| | | | | | | | | | | |
|---|---|---|---|---|---|---|---|---|---|---|
| Close adhesiveness evaluation | S | S | A | B | B | C | D | C | D | E |

As shown in Table 2, the close adhesiveness evaluation results after heating and elongation of the decorative sheets in Examples 3 to 11 were better than the result in Comparative Example 5.

As described above, in the present disclosure, for example, the following inventions are provided.

[1]

A decorative sheet for vacuum forming, the decorative sheet comprising:
a first vinyl chloride based resin layer;
a design layer;
a second vinyl chloride based resin layer; and
a surface protective layer in this order, in a thickness direction, wherein
the first vinyl chloride based resin layer and the second vinyl chloride based resin layer respectively include vinyl chloride based resin and aliphatic dibasic acid based plasticizer;
a nanoindentation hardness of the first vinyl chloride based resin layer, in a cross-section in a thickness direction, is 160 MPa or less; and
a nanoindentation hardness of the second vinyl chloride based resin layer, in a cross-section in a thickness direction, is 165 MPa or more.
   [2]

The decorative sheet for vacuum forming according to [1], wherein the first vinyl chloride based resin layer and the second vinyl chloride based resin layer respectively include adipic acid ester as the aliphatic dibasic acid based plasticizer.

[3]

The decorative sheet for vacuum forming according to [1] or [2], wherein the first vinyl chloride based resin layer and the second vinyl chloride based resin layer respectively include diisononyl adipate as the aliphatic dibasic acid based plasticizer.

[4]

The decorative sheet for vacuum forming according to any one of [1] to [3], wherein an amount of the aliphatic dibasic acid based plasticizer in the first vinyl chloride based resin layer is more than an amount of the aliphatic dibasic acid based plasticizer in the second vinyl chloride based resin layer.

[5]

The decorative sheet for vacuum forming according to any one of [1] to [4], wherein the amount of the aliphatic dibasic acid based plasticizer in the first vinyl chloride based resin layer is 5 parts by mass or more and 15 parts by mass or less, with respect to 100 parts by mass of the vinyl chloride based resin, and the amount of the aliphatic dibasic acid based plasticizer in the second vinyl chloride based resin layer is 1 part by mass or more and less than 15 parts by mass, with respect to 100 parts by mass of the vinyl chloride based resin.

[6]

The decorative sheet for vacuum forming according to any one of [1] to [5], wherein a thickness of the first vinyl chloride based resin layer is 60 μm or more and 200 μm or less.

[7]

The decorative sheet for vacuum forming according to any one of [1] to [6], wherein a thickness of the second vinyl chloride based resin layer is 100 μm or more and 250 μm or less.

[8]

The decorative sheet for vacuum forming according to any one of [1] to [7], wherein a thickness of the surface protective layer is 10 μm or less.

[9]

The decorative sheet for vacuum forming according to any one of [1] to [8], wherein the second vinyl chloride based resin layer has a convexoconcave shape including a convex portion and a concave portion, on a surface that is opposite side to the design layer;
the decorative sheet includes a brightness layer including a glittering pigment and a resin component, on a surface of the second vinyl chloride based resin layer that is opposite side to the design layer; and
the brightness layer is disposed in the concave portion.
   [10]

The decorative sheet according to [9], wherein the brightness layer includes an acrylic based resin as the resin component.

[11]

The decorative sheet according to [10], wherein a content of the acrylic based resin in the brightness layer is 30 parts by mass or more and 100 parts by mass or less, with respect to 100 parts by mass of a total amount of the resin component.

[12]

The decorative sheet for vacuum forming according to any one of [9] to [11], wherein an average particle size of the glittering pigment is 5 μm or more and 25 μm or less.

[13]

The decorative sheet for vacuum forming according to any one of [9] to [12], wherein a content of the glittering pigment in the brightness layer is more than 0 parts by mass and 60 parts by mass or less, with respect to 100 parts by mass of the resin component.

[14]

The decorative sheet for vacuum forming according to any one of [9] to [13], wherein a depth of the concave portion in the second vinyl chloride based resin layer is 10 μm or more and 100 μm or less.

[15]

The decorative sheet for vacuum forming according to any one of [9] to [14], wherein the brightness layer includes a vinyl chloride-vinyl acetate copolymer as the resin component.

[16]

The decorative sheet according to [15], wherein a content of the vinyl chloride-vinyl acetate copolymer in the brightness layer is more than 0 parts by mass and 70 parts by mass or less, with respect to 100 parts by mass of a total amount of the resin component.

[17]

The decorative sheet for vacuum forming according to any one of [9] to [16], wherein an average particle size of the glittering pigment is 5 μm or more and 60 μm or less.

[18]

The decorative sheet for vacuum forming according to any one of [9] to [17], wherein a content of the glittering pigment in the brightness layer is more than 0 parts by mass and 80 parts by mass or less, with respect to 100 parts by mass of the resin component.

[19]

The decorative sheet for vacuum forming according to any one of [9] to [18], wherein a depth of the concave portion in the second vinyl chloride based resin layer is 10 μm or more and 400 μm or less.

[20]

A method for producing a decorative sheet for vacuum forming, the method comprising:
a design layer forming step of forming a design layer on one surface of a first vinyl chloride based resin layer;
a disposing step of disposing a second vinyl chloride based resin layer on a surface of the design layer that is opposite side to the first vinyl chloride based resin layer; and
a surface protective layer forming step of forming a surface protective layer on a surface of the second vinyl chloride based resin layer that is opposite side to the design layer, wherein
the first vinyl chloride based resin layer and the second vinyl chloride based resin layer respectively include vinyl chloride based resin and aliphatic dibasic acid based plasticizer;
a nanoindentation hardness of the first vinyl chloride based resin layer, in a cross-section in a thickness direction, is 160 MPa or less; and
a nanoindentation hardness of the second vinyl chloride based resin layer, in a cross-section in a thickness direction, is 165 MPa or more.

[21] The method for producing a decorative sheet for vacuum forming according to further comprising:
after the disposing step, an embossing process step of forming a convexoconcave shape including a convex portion and a concave portion by subjecting a surface of the second vinyl chloride based resin layer, that is opposite side to the design layer, to an embossing process; and
a brightness layer forming step of forming a brightness layer by filling the concave portion with a glittering ink by applying the glittering ink to a surface of the second vinyl chloride based resin layer, and wiping, wherein
the glittering ink used in the brightness layer forming step includes a glittering pigment and a resin with a glass transition temperature higher than 70° C.
   [22]

The method for producing a decorative sheet for vacuum forming according to [21], wherein the resin with a glass transition temperature higher than 70° C. includes acrylic polyol.

[23]

The method for producing a decorative sheet for vacuum forming according to or [22], wherein the glittering ink further includes a resin with a glass transition temperature of 70° C. or less.

[24]

The method for producing a decorative sheet for vacuum forming according to [23], wherein the resin with a glass transition temperature of 70° C. or less includes a vinyl chloride-vinyl acetate copolymer.

[25]

A decorative member comprising:
a base member; and
the decorative sheet for vacuum forming according to any one of [1] to [19].
   [26]

A method for producing the decorative member according to [25], the method comprising:
a preparing step of preparing a base member and the decorative sheet for vacuum forming:
a softening step of softening the decorative sheet for vacuum forming by heating; and
a vacuum adsorbing step of vacuum adsorbing the softened decorative sheet for vacuum forming to a shape of the base member by a decompression operation.
   [27]

The method for producing a decorative member according to [26], wherein in the softening step, the decorative sheet for vacuum forming is softened by heating the decorative sheet for vacuum forming to a temperature higher than 70° C.

### REFERENCE SIGNS LIST

1: first vinyl chloride based resin layer
2: design layer
3: second vinyl chloride based resin layer
4: surface protective layer
5: brightness layer
6: rear surface primer layer
10: decorative sheet for vacuum forming
20: adhesive layer
30: base member
100: decorative member

1. A decorative sheet for vacuum forming, the decorative sheet comprising:
a first vinyl chloride based resin layer;
a design layer;
a second vinyl chloride based resin layer; and
a surface protective layer in this order, in a thickness direction, wherein
the first vinyl chloride based resin layer and the second vinyl chloride based resin layer respectively include vinyl chloride based resin and aliphatic dibasic acid based plasticizer;
a nanoindentation hardness of the first vinyl chloride based resin layer, in a cross-section in a thickness direction, is 160 MPa or less; and
a nanoindentation hardness of the second vinyl chloride based resin layer, in a cross-section in a thickness direction, is 165 MPa or more.

2. The decorative sheet for vacuum forming according to claim 1, wherein the first vinyl chloride based resin layer and the second vinyl chloride based resin layer respectively include adipic acid ester as the aliphatic dibasic acid based plasticizer.

3. The decorative sheet for vacuum forming according to claim 1, wherein the first vinyl chloride based resin layer and the second vinyl chloride based resin layer respectively include diisononyl adipate as the aliphatic dibasic acid based plasticizer.

4. The decorative sheet for vacuum forming according to claim 1, wherein an amount of the aliphatic dibasic acid based plasticizer in the first vinyl chloride based resin layer is more than an amount of the aliphatic dibasic acid based plasticizer in the second vinyl chloride based resin layer.

5. The decorative sheet for vacuum forming according to claim 1, wherein the amount of the aliphatic dibasic acid based plasticizer in the first vinyl chloride based resin layer is 5 parts by mass or more and 15 parts by mass or less, with respect to 100 parts by mass of the vinyl chloride based resin, and the amount of the aliphatic dibasic acid based plasticizer in the second vinyl chloride based resin layer is 1 part by mass or more and less than 15 parts by mass, with respect to 100 parts by mass of the vinyl chloride based resin.

6. The decorative sheet for vacuum forming according to claim 1, wherein a thickness of the first vinyl chloride based resin layer is 60 μm or more and 200 μm or less.

7. The decorative sheet for vacuum forming according to claim 1, wherein a thickness of the second vinyl chloride based resin layer is 100 μm or more and 250 μm or less.

8. The decorative sheet for vacuum forming according to claim 1, wherein a thickness of the surface protective layer is 10 μm or less.

9. The decorative sheet for vacuum forming according to claim 1, wherein the second vinyl chloride based resin layer has a convexoconcave shape including a convex portion and a concave portion, on a surface that is opposite side to the design layer;
the decorative sheet includes a brightness layer including a glittering pigment and a resin component, on a surface of the second vinyl chloride based resin layer that is opposite side to the design layer; and
the brightness layer is disposed in the concave portion.

10. The decorative sheet according to claim 9, wherein the brightness layer includes an acrylic based resin as the resin component.

11. The decorative sheet according to claim 10, wherein a content of the acrylic based resin in the brightness layer is 30 parts by mass or more and 100 parts by mass or less, with respect to 100 parts by mass of a total amount of the resin component.

12. The decorative sheet for vacuum forming according to claim 9, wherein an average particle size of the glittering pigment is 5 μm or more and 25 μm or less.

13. The decorative sheet for vacuum forming according to claim 9, wherein a content of the glittering pigment in the brightness layer is more than 0 parts by mass and 60 parts by mass or less, with respect to 100 parts by mass of the resin component.

14. The decorative sheet for vacuum forming according to claim 9, wherein a depth of the concave portion in the second vinyl chloride based resin layer is 10 μm or more and 100 μm or less.

15. The decorative sheet for vacuum forming according to claim 10, wherein the brightness layer includes a vinyl chloride-vinyl acetate copolymer as the resin component.

16. The decorative sheet according to claim 15, wherein a content of the vinyl chloride-vinyl acetate copolymer in the brightness layer is more than 0 parts by mass and 70 parts by mass or less, with respect to 100 parts by mass of a total amount of the resin component.

17. The decorative sheet for vacuum forming according to claim 15, wherein an average particle size of the glittering pigment is 5 μm or more and 60 μm or less.

18. The decorative sheet for vacuum forming according to claim 15, wherein a content of the glittering pigment in the brightness layer is more than 0 parts by mass and 80 parts by mass or less, with respect to 100 parts by mass of the resin component.

19. The decorative sheet for vacuum forming according to claim 15, wherein a depth of the concave portion in the second vinyl chloride based resin layer is 10 μm or more and 400 μm or less.

20. A method for producing a decorative sheet for vacuum forming, the method comprising:
a design layer forming step of forming a design layer on one surface of a first vinyl chloride based resin layer;
a disposing step of disposing a second vinyl chloride based resin layer on a surface of the design layer that is opposite side to the first vinyl chloride based resin layer; and
a surface protective layer forming step of forming a surface protective layer on a surface of the second vinyl chloride based resin layer that is opposite side to the design layer, wherein
the first vinyl chloride based resin layer and the second vinyl chloride based resin layer respectively include vinyl chloride based resin and aliphatic dibasic acid based plasticizer;
a nanoindentation hardness of the first vinyl chloride based resin layer, in a cross-section in a thickness direction, is 160 MPa or less; and
a nanoindentation hardness of the second vinyl chloride based resin layer, in a cross-section in a thickness direction, is 165 MPa or more.

21-27. (canceled)
